(19) United States
(12) Patent Application Publication
(10) Pub. No.: US 2021/0363391 A1
(43) Pub. Date: Nov. 25, 2021

(54) PRESSURE-SENSITIVE ADHESIVE LAYER, OPTICAL FILM HAVING PRESSURE-SENSITIVE ADHESIVE LAYER, OPTICAL LAMINATE, AND IMAGE DISPLAY DEVICE

(71) Applicant: NITTO DENKO CORPORATION, Ibaraki-shi, Osaka (JP)

(72) Inventors: Tomoyuki Kimura, Ibaraki-shi (JP); Hirotomo Ono, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/636,424

(22) PCT Filed: Aug. 7, 2018
(86) PCT No.: PCT/JP2018/029583

§ 371 Date: Feb. 4, 2020

(30) Foreign Application Priority Data
Aug. 7, 2017 (JP) 2017-152533

(51) Int. Cl. C09J 7/38; C08F 220/06; C08F 220/18; C08F 220/20; C08F 220/30; C08K 5/14; C08K 5/5419; C08G 77/38; C08G 77/46; C08G 18/76; C08G 18/73; B32B 7/12; B32B 27/08

(52) U.S. Cl. CPC C09J 7/385; B32B 2457/20; C08F 220/1804; C08F 220/20; C08F 220/30; C08K 5/14; C08K 5/5419; C08G 77/38; C08G 77/46; C08G 18/7621; C08G 18/73; B32B 7/12; B32B 27/08; C09J 2203/318; C09J 2301/162; C09J 2301/312; C09J 2433/00; C09J 2483/00; C09J 2467/006; B32B 2250/24; B32B 2307/412; B32B 2307/202; B32B 2307/714; C08F 220/06

(57) ABSTRACT

A pressure-sensitive adhesive layer formed from a pressure-sensitive adhesive composition containing, as monomer units, at least a (meth)acrylic polymer (A) that contains an alkyl (meth)acrylate, and a silicon compound (B), wherein: the silicon compound (B) is one or more silicon compounds selected from the group consisting of alkoxysilane compounds and organopolysiloxane compounds having an acidic group or an acid anhydride group derived from an acidic group and having no polyether group in the molecule, and/or a hydrolytic condensate thereof; and the pressure-sensitive adhesive layer satisfies the conditions of the resistance value change ratio represented by general formula (1). Formula (1): R₂₅₀/Rᵢ≤3.0. This pressure-sensitive adhesive layer has reworkability with respect to a transparent conductive layer, corrosion resistance, and high durability.

### TECHNICAL FIELD

The present invention relates to a pressure-sensitive adhesive layer, an optical film having a pressure-sensitive adhesive layer, and an optical laminate. More specifically, the present invention relates to an image display device, such as a liquid crystal display, an organic EL display, or PDP, using the optical film having a pressure-sensitive adhesive layer or the optical laminate. As the optical film, a polarizing film, a retardation film, a compensation film, a brightness enhancement film, or a film obtained by laminating them can be used.

### BACKGROUND ART

A liquid crystal display or the like absolutely needs to have polarizing elements provided on both sides of its liquid crystal cell because of its image-forming method, and polarizing films are generally attached. Further, in addition to polarizing films, various optical elements have come to be used for a liquid crystal panel to improve the display quality of a display. Examples of such optical elements include a retardation film for preventing coloration, a viewing angle increasing film for improving the viewing angle of a liquid crystal display, and a brightness enhancement film for enhancing the contrast of a display. These films are collectively called optical films.

A pressure-sensitive adhesive is usually used when an optical member such as the above-described optical film is attached to a liquid crystal cell. An optical film and a liquid crystal cell or optical films are usually closely adhered to each other with a pressure-sensitive adhesive to reduce a loss of light. In such a case, an optical film having a pressure-sensitive adhesive layer, in which a pressure-sensitive adhesive is previously provided on one surface of an optical film as a pressure-sensitive adhesive layer, is generally used because there is an advantage that the optical film can be fixed without a drying process. A release film is usually attached to the pressure-sensitive adhesive layer of the optical film having a pressure-sensitive adhesive layer.

The pressure-sensitive adhesive layer is required to have durability when the optical film having a pressure-sensitive adhesive layer is adhered to the glass substrate of a liquid crystal panel. For example, in an endurance test, such as a heating and humidification test, usually performed as an environmental acceleration test, the optical film having a pressure-sensitive adhesive layer is require to cause no defect resulting from the pressure-sensitive adhesive layer, such as peeling or lifting.

For example, Patent Document 1 discloses, as a pressure-sensitive adhesive layer having such durability as described above, a pressure-sensitive adhesive layer formed of a pressure-sensitive adhesive composition containing an acrylic copolymer of a (meth)acrylic alkyl ester whose alkyl group has 1 to 18 carbon atoms and a functional group-containing monomer, a crosslinking agent, and a silane coupling agent having an acid anhydride group.

Further, from the viewpoint of enhancing the productivity of an image display device such as a liquid crystal display, the pressure-sensitive adhesive layer is required to have a property (reworkability) such that when adhered to the glass substrate of a liquid crystal panel, the optical film having a pressure-sensitive adhesive layer can easily be detached and the pressure-sensitive adhesive does not remain on the glass substrate after detachment.

For example, Patent Document 2 discloses, as a pressure-sensitive adhesive layer having such durability and reworkability as described above, a pressure-sensitive adhesive layer formed of a pressure-sensitive adhesive composition containing a copolymer containing a (meth)acrylic acid ester, an organosiloxane having, in its molecule, an alkoxy group, an acid anhydride group, and a polyether group, and/or a hydrolytic condensate thereof.

On the other hand, there is a case where a transparent conductive layer (e.g., an indium-tin composite oxide layer (ITO layer)) is formed on the glass substrate of a liquid crystal panel. The transparent conductive layer functions as an antistatic layer for preventing display unevenness caused by static electricity, or functions as a shield electrode that separates a driving electric field in a liquid crystal cell and a touch panel from each other when a liquid crystal display is used as a touch panel. Further, in the case of a so-called on-cell touch panel-type liquid crystal panel, a patterned transparent conductive layer is directly formed on the glass substrate of an image display panel so as to function as a sensor electrode of the touch panel. In a liquid crystal display having such a structure, the pressure-sensitive adhesive layer of the optical film having a pressure-sensitive adhesive layer is directly adhered to a transparent conductive layer such as the above-described ITO layer. Therefore, the pressure-sensitive adhesive layer is required to have durability and reworkability not only against glass substrates but also against transparent conductive layers such as ITO layers. In general, adhesion of the pressure-sensitive adhesive layer to a transparent conductive layer such as an ITO layer is inferior to that to a glass substrate, which often causes a problem of durability.

Further, the pressure-sensitive adhesive layer is in direct contact with the transparent conductive layer of a liquid crystal panel. Therefore, there is a problem that depending on the composition of the pressure-sensitive adhesive layer, the pressure-sensitive adhesive layer corrodes the transparent conductive layer so that the resistance value of the transparent conductive layer increases. When the resistance value of the transparent conductive layer increases, static electricity unevenness occurs due to its insufficient antistatic property, or its function as a shield electrode is deteriorated so that a malfunction occurs such as misoperation of a touch panel. In the case of an on-cell touch panel, an increase in the resistance value of a sensor electrode increases the time required for sensing and therefore the speed of response decreases. For this reason, the pressure-sensitive adhesive layer attached to a transparent conductive layer such as an ITO layer is required to prevent an increase in the resistance value of the transparent conductive layer (corrosion resistance) even when subjected to an endurance test such as a heating and humidification test.

For example, Patent Document 3 discloses, as a pressure-sensitive adhesive layer capable of preventing such a change in the resistance value of a transparent conductive layer as described above, a pressure-sensitive adhesive layer formed of a pressure-sensitive adhesive composition containing a polymer containing a (meth)acrylic acid ester and a thiol compound.

### PRIOR ART DOCUMENTS

### Patent Documents

Patent Document 1: JP-A-2006-265349

Patent Document 2: JP-A-2013-216726

Patent Document 3: JP-T-2014-501796

### SUMMARY OF THE INVENTION

### Problems to be Solved by the Invention

Further, image display devices such as liquid crystal displays have recently been used as in-car devices. In-car image display devices are used in a higher temperature range than image display devices for home electrical appliances. Therefore, the pressure-sensitive adhesive layer is required to have durability (high durability) in a high temperature range and a high temperature and humidity range to prevent foaming or peeling.

However, the pressure-sensitive adhesive layers disclosed in Patent Document 1 and Patent Document 2 do not satisfy requirements for such reworkability, corrosion resistance, and high durability against a transparent conductive layer as described above. Further, the pressure-sensitive adhesive layer disclosed in Patent Document 3 is poor in at least such reworkability and high durability against a transparent conductive layer as described above.

In light of the above circumstances, it is an object of the present invention to provide a pressure-sensitive adhesive layer having reworkability, corrosion resistance, and high durability against a transparent conductive layer.

Further, it is also an object of the present invention to provide an optical film having a pressure-sensitive adhesive layer which has the above-described pressure-adhesive layer, an optical laminate having the above-described optical film having a pressure-sensitive adhesive layer adhered thereto, and an image display device using the optical film having a pressure-sensitive adhesive layer or the optical laminate.

### Means for Solving the Problems

More specifically, the present invention relates to a pressure-sensitive adhesive layer including a pressure-sensitive adhesive composition containing a (meth)acrylic polymer (A) containing at least an alkyl (meth)acrylate as a monomer unit and a silicon compound (B), wherein the silicon compound (B) is at least one silicon compound selected from the group consisting of an alkoxysilane compound and an organopolysiloxane compound which have an acidic group or an acid anhydride group derived from an acidic group but have no polyether group in a molecule, and/or a hydrolytic condensate thereof, and the pressure-sensitive adhesive layer satisfies a condition of a resistance value change ratio represented by a general formula (1): R₂₅₀/Rᵢ≤3.0. Here, the Ri represents a surface resistance value (Ω/□) of an indium-tin composite oxide layer at a time when a laminate, which is obtained by adhering the pressure-sensitive adhesive layer of a polarizing film having a pressure-sensitive adhesive layer which has a polarizing film and the pressure-sensitive adhesive layer to the indium-tin composite oxide layer of a transparent conductive substrate having a transparent substrate and the indium-tin composite oxide layer, is subjected to autoclave treatment under conditions of 50° C. and 5 atmospheres for 15 minutes, and the R₂₅₀ represents a surface resistance value (Ω/□) of the indium-tin composite oxide layer at a time when the laminate that has been subjected to autoclave treatment is subjected to high-temperature and high-humidity treatment under conditions of 65° C. and 95% RH for 250 hours.

In the present invention, the pressure-sensitive adhesive layer preferably satisfies a condition of a resistance value change ratio represented by a general formula (2): R₅₀₀/R₂₅₀≤1.8. Here, the R₅₀₀ represents a surface resistance value (Ω/□) of the indium-tin composite oxide layer at a time when the laminate that has been subjected to autoclave treatment is subjected to high-temperature and high-humidity treatment under conditions of 65° C. and 95% RH for 500 hours.

In the pressure-sensitive adhesive layer according to the present invention, the acidic group or the acid anhydride group derived from an acidic group in the silicon compound (B) is preferably a carboxyl group or a carboxylic anhydride group.

In the pressure-sensitive adhesive layer according to the present invention, an amount of the silicon compound (B) is preferably 0.05 to 10 parts by weight per 100 parts by weight of the (meth)acrylic polymer (A).

In the pressure-sensitive adhesive layer according to the present invention, the pressure-sensitive adhesive composition preferably contains a reactive functional group-containing silane coupling agent, and the reactive functional group is preferably a functional group other than an acid anhydride group.

In the pressure-sensitive adhesive layer according to the present invention, the functional group other than an acid anhydride group is preferably at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group.

In the pressure-sensitive adhesive layer according to the present invention, an amount of the reactive functional group-containing silane coupling agent is preferably 0.01 to 10 parts by weight per 100 parts by weight of the (meth)acrylic polymer (A).

In the pressure-sensitive adhesive layer according to the present invention, the pressure-sensitive adhesive composition preferably further contains, as a monomer unit, at least one copolymerizable monomer selected from the group consisting of an aromatic-containing (meth)acrylate, an amide group-containing monomer, a carboxyl group-containing monomer, and a hydroxyl group-containing monomer.

In the pressure-sensitive adhesive layer according to the present invention, the amount of the carboxyl group-containing monomer is preferably 0.1 to 15% by weight with respect to a total amount of monomer components forming the (meth)acrylic polymer (A).

In the pressure-sensitive adhesive layer according to the present invention, the pressure-sensitive adhesive composition preferably contains a crosslinking agent.

The pressure-sensitive adhesive layer according to the present invention preferably has an adhesive force to an indium-tin composite oxide layer of 15 N/25 mm or less under conditions of a peel angle of 90° and a peel rate of 300 mm/min.

The present invention also relates to an optical film having a pressure-sensitive adhesive layer which includes an optical film and the above-described pressure-sensitive adhesive layer.

The present invention also relates to an optical laminate comprising a transparent conductive substrate having a transparent substrate and a transparent conductive layer and the above-described optical film having a pressure-sensitive adhesive layer, wherein the pressure-sensitive adhesive layer of the optical film having a pressure-sensitive adhesive layer is adhered to the transparent conductive layer of transparent conductive substrate.

The present invention also relates to an image display device using the above-described optical film having a pressure-sensitive adhesive layer or the above-described optical laminate.

### Effect of the Invention

### <Corrosion Resistance>

The adhesive composition forming the pressure-sensitive adhesive layer according to the present invention contains a (meth)acrylic polymer (A) containing at least an alkyl (meth)acrylate as a monomer unit and a silicon compound (B). The silicon compound (B) is at least one silicon compound selected from the group consisting of an alkoxysilane compound and an organopolysiloxane compound which have an acidic group or an acid anhydride group derived from an acidic group but have no polyether group in a molecule, and/or a hydrolytic condensate thereof, and the pressure-sensitive adhesive layer satisfies a condition of a resistance value change ratio represented by the general formula (1): R₂₅₀/Rᵢ≤3.0, and therefore even after an image display panel using the pressure-sensitive adhesive layer is subjected to an endurance test such as a heating and humidification test, the antistatic function and the shielding function of a transparent conductive layer are not impaired, and further a reduction in the response speed of an on-cell touch panel can be prevented.

When the pressure-sensitive adhesive layer is adhered to a transparent conductive layer, the silicon compound (B) contained in the pressure-sensitive adhesive layer according to the present invention segregates at the interface between the transparent conductive layer and the pressure-sensitive adhesive layer. As a result, a coating layer derived from the silicon compound (B) is estimated to be formed at the interface between the transparent conductive layer and the pressure-sensitive adhesive layer. The formation of the coating layer prevents corrosive substances (e.g., acidic components and iodine derived from a polarizing plate) contained in the pressure-sensitive adhesive layer from migrating to the transparent conductive layer, and therefore even after long-term exposure to heating conditions or humidification conditions, corrosion of the transparent conductive layer is prevented, and the resistance value change ratio represented by the general formula (1) or (2) can be kept low.

The silicon compound (B) has an acidic group or an acid anhydride group derived from an acidic group in its molecule. The acid anhydride group is hydrolyzed in the pressure-sensitive adhesive layer to generate an acidic group. On the other hand, in the surface of a transparent conductive layer such as ITO, some of hydroxyl groups present in the surface of the transparent conductive layer are desorbed as hydroxide ions so that metallic cations (in the case of ITO, for example, indium cations) are generated in the surface of the transparent conductive layer. It is estimated that the acidic group is neutralized with the hydroxide ion near the surface of the transparent conductive layer, and an anion generated by deprotonation of the acidic group and the metallic cation in the surface of the transparent conductive layer form an ionic bond (i.e., the acidic group of the silicon compound (B) and the transparent conductive layer react in an acid-base reaction) so that the silicon compound (B) is trapped at the interface between the transparent conductive layer and the pressure-sensitive adhesive layer, and therefore segregation to the transparent conductive layer occurs.

The (meth)acrylic polymer (A) contained in the pressure-sensitive adhesive layer according to the present invention preferably contains, as a monomer unit, a carboxyl group-containing monomer as long as the resistance value change ratio of a transparent conductive layer satisfies the general formula (1). The carboxyl group-containing monomer is effective at improving durability against the transparent conductive layer, but there is a problem that the carboxyl group-containing monomer increases the resistance value of the transparent conductive layer. However, by appropriately adjusting the copolymerization ratio of the carboxyl group-containing monomer in the pressure-sensitive adhesive layer of the present invention, it is possible to prevent the corrosion of a transparent conductive layer, thereby providing a pressure-sensitive adhesive layer that can achieve both high durability such that foaming and peeling do not occur even under severe endurance test conditions that in-car displays are required to withstand and the antistatic function, the shielding function, and the sensing performance of the transparent conductive layer.

Further, the (meth)acrylic polymer (A) preferably contains an amide group-containing monomer as a monomer unit. The amide group-containing monomer neutralizes an acidic component contained in the pressure-sensitive adhesive layer, and is therefore effective at keeping the resistance value change ratio of a transparent conductive layer represented by the general formula (1) or (2) low. Examples of the acidic component contained in the pressure-sensitive adhesive layer include a carboxyl group-containing monomer and a side reaction product of a peroxide crosslinking agent such as benzoyl peroxide (e.g., benzoic acid). Particularly, when the (meth)acrylic polymer (A) contains a carboxyl group-containing monomer, combination with the amide group-containing monomer makes it possible to provide a pressure-sensitive adhesive layer having higher durability without impairing the antistatic function, the shielding function, and the sensing performance of the transparent conductive layer.

The pressure-sensitive adhesive layer according to the present invention more preferably contains a phosphonic acid-based compound represented by a general formula (8) or a phosphoric acid-based compound or a salt thereof. The phosphonic acid-based compound or the phosphoric acid-based compound or the salt thereof selectively adsorbs to a transparent conductive layer to form a coating layer at the interface between the transparent conductive layer and the pressure-sensitive adhesive layer. The coating layer prevents corrosive substances contained in the pressure-sensitive adhesive layer from migrating to the transparent conductive layer, and therefore even after long-term exposure to heating conditions or humidification conditions, corrosion of the transparent conductive layer is prevented, and the resistance value change ratio represented by the general formula (1) or (2) can be kept low.

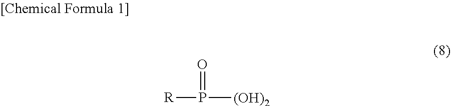

(wherein R is a hydrogen atom or a hydrocarbon group that has 1 to 18 carbon atoms and may contain an oxygen atom).

The silicon compound (B) has no polyether group in its molecule, and therefore there is no steric hindrance caused by a bulky polyether group. Therefore, it is estimated that the coating layer formed at the interface between a transparent conductive layer and the pressure-sensitive adhesive layer has a denser structure, and therefore migration of corrosive substances contained in the pressure-sensitive adhesive layer to the transparent conductive layer can effectively be prevented. When the silicon compound (B) has a polyether group in its molecule, the effect of the amide group-containing monomer or the phosphoric acid ester compound on preventing the corrosion of the transparent conductive layer tends to reduce. The reason for this is estimated that when a silicon compound having a highly hydrophilic polyether group segregates at the interface between the transparent conductive layer and the pressure-sensitive adhesive, corrosive substances in the transparent conductive layer, such as acidic components in the pressure-sensitive adhesive and iodine, are also attracted to the interface between the transparent conductive layer and the pressure-sensitive adhesive layer.

### <Reworkability>

When the pressure-sensitive adhesive layer according to the present invention is peeled off from an adherend such as an image display panel, the silicon compound (B) segregating at the interface between a transparent conductive layer and the pressure-sensitive adhesive layer functions as a fragile layer, and breakage of the fragile layer promotes the peeling-off of the pressure-sensitive adhesive layer so that adhesive force can appropriately be reduced. Therefore, the pressure-sensitive adhesive layer of the present invention has excellent reworkability.

### <High Durability>

A transparent conductive layer is generally less likely to adhere to the pressure-sensitive adhesive layer than glass, and therefore foaming or peeling of the pressure-sensitive adhesive layer is likely to occur. In the case of the pressure-sensitive adhesive layer according to the present invention, the silicon compound (B) segregates to a transparent conductive layer, and therefore organic functional groups such as an acidic group and an alkoxysilyl group are introduced into the interface between the transparent conductive layer and the pressure-sensitive adhesive layer. It is estimated that such organic functional groups derived from the silicon compound (B) function to improve adhesion to the pressure-sensitive adhesive layer in an endurance test performed under a high temperature condition or a high temperature and humidity condition by forming a bond with a polar group contained in the (meth)acrylic polymer (A) or forming a bond between molecules of the silicon compound (B). Therefore, the pressure-sensitive adhesive layer according to the present invention also has durability against a transparent conductive layer such that foaming or peeling can be prevented in an endurance test.

Particularly preferred examples of the polar group contained in the (meth)acrylic polymer (A) include a hydroxyl group or a carboxyl group forming a hydrogen bond with an acidic group of the silicon compound (B), an amide group or an amino group forming an ionic bond with an acidic group of the silicon compound (B) by an acid-base reaction, and an alkoxysilyl group or a silanol group forming a hydrogen bond with an alkoxysilyl group of the silicon compound (B) or a covalent bond with an alkoxysilyl group of the silicon compound (B) by dehydration condensation.

When the pressure-sensitive adhesive composition forming the pressure-sensitive adhesive layer according to the present invention contains a silane coupling agent having a reactive functional group other than an acid anhydride, combined action with the silicon compound (B) is estimated developed, and therefore a pressure-sensitive adhesive layer having more excellent durability can be obtained.

### BRIEF DESCRIPTION OF THE DRAWING

FIG. 1 is a cross-sectional view schematically showing an embodiment of a liquid crystal panel that can be used in the present invention.

### MODE FOR CARRYING OUT THE INVENTION

Hereinbelow, embodiments of the present invention will be described in detail.

The present invention relates to a pressure-sensitive adhesive layer including a pressure-sensitive adhesive composition containing a (meth)acrylic polymer (A) containing at least an alkyl (meth)acrylate as a monomer unit and a silicon compound (B), wherein the silicon compound (B) is at least one silicon compound selected from the group consisting of an alkoxysilane compound and an organopolysiloxane compound which have an acidic group or an acid anhydride group derived from an acidic group but have no polyether group in a molecule, and/or a hydrolytic condensate thereof, and the pressure-sensitive adhesive layer satisfies a condition of a resistance value change ratio represented by a general formula (1): R₂₅₀/Rᵢ≤3.0, wherein the Rᵢ represents a surface resistance value (Ω/□) of an indium-tin composite oxide layer at a time when a laminate, which is obtained by adhering the pressure-sensitive adhesive layer of a polarizing film having a pressure-sensitive adhesive layer which has a polarizing film and the pressure-sensitive adhesive layer to the indium-tin composite oxide layer of a transparent conductive substrate having a transparent substrate and the indium-tin composite oxide layer, is subjected to autoclave treatment under conditions of 50° C. and 5 atmospheres for 15 minutes, and the R₂₅₀ represents a surface resistance value (Ω/□) of the indium-tin composite oxide layer at a time when the laminate that has been subjected to autoclave treatment is subjected to high temperature and high humidity treatment under conditions of 65° C. and 95% RH for 250 hours.

The resistance value change ratio between the R₂₅₀ and the Rᵢ(R₂₅₀/Rᵢ) of the pressure-sensitive adhesive layer according to the present invention is preferably 3 or less, more preferably 2.5 or less, even more preferably 2 or less, particularly preferably 1.5 or less, most preferably 1.3 or less.

In the present invention, the pressure-sensitive adhesive layer preferably satisfies the condition of a resistance value change ratio represented by a general formula (2): R₅₀₀/R₂₅₀≤1.8. The R₅₀₀ represents a surface resistance value (Ω/□) of the indium-tin composite oxide layer at a time when the laminate that has been subjected to autoclave treatment is subjected to high-temperature and high-humidity treatment under conditions of 65° C. and 95% RH for 500 hours.

The resistance value change ratio between the R₅₀₀ and the R₂₅₀ (R₅₀₀/R₂₅₀) of the pressure-sensitive adhesive layer according to the present invention is preferably 1.8 or less, more preferably 1.6 or less, even more preferably 1.4 or less, particularly preferably 1.2 or less.

The pressure-sensitive adhesive layer according to the present invention relates to a pressure-sensitive adhesive composition containing a (meth)acrylic polymer (A) containing at least an alkyl (meth)acrylate as a monomer unit and a silicon compound (B). The pressure-sensitive adhesive layer according to the present invention can satisfy the general formula (1) and/or the general formula (2) by allowing the pressure-sensitive adhesive composition containing a (meth)acrylic polymer (A) containing an alkyl (meth)acrylate and a silicon compound (B) to contain at least one silicon compound (B) selected from the group consisting of an alkoxysilane compound and an organopolysiloxane compound which have an acidic group or an acid anhydride group derived from an acidic group but have no polyether group in a molecule and by combining the pressure-sensitive adhesive composition with the following formulations (a) to (d). However, the combination of these formulations is merely illustrative, and formulations to be combined are not limited thereto.

(a) As a monomer component of the (meth)acrylic polymer (A), the above-described carboxyl group-containing monomer is used, and the (meth)acrylic polymer (A) contains the carboxyl group-containing monomer in an amount of 0.1 to 15 wt % with respect to the total amount of the monomer components forming the (meth)acrylic polymer (A). This makes it possible to further improve the reworkability, durability, and metal corrosion resistance of the pressure-sensitive adhesive layer. The upper limit of the amount of the carboxyl group-containing monomer to be copolymerized is more preferably 8 wt % or less, even more preferably 6 wt % or less. The lower limit of the amount of the carboxyl group-containing monomer to be copolymerized is more preferably 0.3 wt % or more, even more preferably 1 wt % or more, particularly preferably 4.5 wt % or more. If the amount of the carboxyl group-containing monomer to be copolymerized is too large, a transparent conductive layer tends to corrode and reworkability tends to deteriorate. If the amount of the carboxyl group-containing monomer to be copolymerized is too small, durability tends to reduce.

(b) As the above-described monomer component, the above-described amide group-containing monomer is used, and the (meth)acrylic polymer (A) contains the amide group-containing monomer in an amount of 0.1 to 20 wt % with respect to the total amount of the monomer components forming the (meth)acrylic polymer (A). This makes it possible to further improve the reworkability and durability of the pressure-sensitive adhesive layer. The upper limit of the amount of the amide group-containing monomer to be copolymerized is more preferably 10 wt % or less, even more preferably 4.5 wt % or less. The lower limit of the amount of the amide group-containing monomer to be copolymerized is more preferably 0.3 wt % or more, even more preferably 1 wt % or more. If the amount of the amide group-containing monomer to be copolymerized is too large, reworkability against glass particularly tends to deteriorate. If the amount of the amide group-containing monomer to be copolymerized is too small, the effect of preventing corrosion of a transparent conductive layer is poor, and therefore durability tends to reduce.

(c) The above-described carboxyl group-containing monomer and the amide group-containing monomer are used in combination, and the ratio of amide group-containing monomer/carboxyl group-containing monomer is 0.2 or more. The ratio of amide group-containing monomer/carboxyl group-containing monomer is more preferably 0.5 or more, more preferably 1.0 or more, particularly preferably 2.0 or more, most preferably 4.0 or more. If the ratio of amide group-containing monomer/carboxyl group-containing monomer is less than 0.5, the effect of preventing corrosion of a transparent conductive layer tends to reduce.

(d) The above-described phosphonic acid-based compound or phosphoric acid-based compound represented by the general formula (8) or a salt thereof is used, and the amount of the phosphonic acid-based compound or the phosphoric acid-based compound or the salt thereof to be added is 0.005 parts by weight to 3 parts by weight with respect to 100 parts by weight of the (meth)acrylic polymer (A). The lower limit of the amount of the phosphonic acid-based compound or the phosphoric acid-based compound or the salt thereof to be added is more preferably 0.01 parts by weight or more, even more preferably 0.02 parts by weight or more. The upper limit of the amount of the phosphonic acid-based compound or the phosphoric acid-based compound or the salt thereof to be added is more preferably 2 parts by weight or less, particularly preferably 1.5 parts by weight or less, most preferably 1 part by weight or less. When the amount of the phosphonic acid-based compound to be added is within the above range, corrosion of a transparent conductive layer can be prevented, and durability against heating and humidification is improved. If the amount of the phosphonic acid-based compound to be added is less than 0.005 parts by weight, corrosion of a transparent conductive layer cannot sufficiently be prevented so that the surface resistance value of the transparent conductive layer increases. If the amount of the phosphonic acid-based compound to be added exceeds 3 parts by weight, corrosion of a transparent conductive layer can be prevented, but durability against heating and humidification reduces. Particularly, a combination of the phosphonic acid-based compound and the acrylic acid-containing polymer makes it possible to improve durability due to the effect of acrylic acid on improving adhesion and to further prevent corrosion of a transparent conductive layer. In the present invention, when two or more phosphonic acid-based compounds are used, these phosphonic acid-based compounds are added so that the total amount of the phosphonic acid-based compounds falls within the above range.

### <(Meth)acrylic Polymer (A)>

The (meth)acrylic polymer (A) used in the present invention contains the above-described alkyl (meth)acrylate as a main component. It is to be noted that “(meth)acrylate” refers to acrylate and/or methacrylate, and “(meth)” is used in the same sense in the present invention.

Examples of the alkyl (meth)acrylate constituting the main skeleton of the (meth)acrylic polymer (A) include those whose linear of branched alkyl group has 1 to 18 carbon atoms. Examples of the alkyl group include a methyl group, an ethyl group, a propyl group, an isopropyl group, a butyl group, an isobutyl group, an amyl group, a hexyl group, a cyclohexyl group, a heptyl group, a 2-ethylhexyl group, an isooctyl group, a nonyl group, a decyl group, an isodecyl group, a dodecyl group, an isomyristyl group, a lauryl group, a tridecyl group, a pentadecyl group, a hexadecyl group, a heptadecyl group, and an octadecyl group. The above-mentioned alkyl (meth)acrylates may be used singly or in combination of two or more of them. The average number of carbon atoms in the alkyl group is preferably 3 to 9.

As a monomer constituting the (meth)acrylic polymer (A) other than the alkyl (meth)acrylate, at least one copolymerizable monomer selected from the group consisting of an aromatic ring-containing (meth)acrylate, an amide group-containing monomer, a carboxyl group-containing monomer, and a hydroxyl group-containing monomer can be mentioned. These copolymerizable monomers may be used singly or in combination of two or more of them.

The aromatic ring-containing (meth)acrylate is a compound containing an aromatic ring structure in its structure and having a (meth)acryloyl group. Examples of the aromatic ring include a benzene ring, a naphthalene ring, a biphenyl ring. The aromatic ring-containing (meth)acrylate is effective at adjusting a phase difference caused by the application of stress to the pressure-sensitive adhesive layer due to the shrinkage of an optical film, and therefore the occurrence of light leakage caused by shrinkage of the optical film can be prevented.

Examples of the aromatic ring-containing (meth)acrylate include: benzene ring-containing (meth)acrylates such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethyleneglycol (meth)acrylate, ethylene oxide-modified nonyl phenol (meth)acrylate, ethyleneoxide-modified cresol (meth)acrylate, phenolethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate; naphthalene ring-containing (meth)acrylates such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; and biphenyl ring-containing (meth)acrylates such as biphenyl (meth)acrylate. Among them, benzyl (meth)acrylate and phenoxyethyl (meth)acrylate are preferred from the viewpoint of improving the pressure-sensitive adhesive property and durability of the pressure-sensitive adhesive layer.

The amide group-containing monomer is a compound containing an amide group in its structure and having a polymerizable unsaturated double bond such as a (meth)acryloyl group or a vinyl group. Examples of the amide group-containing monomer include: acrylamide-based monomers such as (meth)acrylamide, N,N-dimethyl (meth)acrylamide, N,N-diethyl (meth)acrylamide, N-isopropylacrylamide, N-methyl (meth)acrylamide, N-butyl (meth)acrylamide, N-hexyl (meth)acrylamide, N-methylol (meth)acrylamide, N-methylol-N-propane (meth)acrylamide, aminomethyl (meth)acrylamide, aminoethyl (meth)acrylamide, mercaptomethyl (meth)acrylamide, and mercaptoethyl (meth)acrylamide; N-acryloyl heterocyclic monomers such as N-(meth)acryloylmorpholine, N-(meth)acryloylpiperidine, and N-(meth)acryloylpyrrolidine; and N-vinyl group-containing lactam-based monomers such as N-vinyl pyrrolidone and N-vinyl-ε-caprolactam. Among them, an N-vinyl group-containing lactam-based monomer is preferred from the viewpoint of improving the durability of the pressure-sensitive adhesive layer against a transparent conductive layer.

The carboxyl group-containing monomer is a compound containing a carboxyl group in its structure and having a polymerizable unsaturated double bond such as a (meth)acryloyl group or a vinyl group. Examples of the carboxyl group-containing monomer include (meth)acrylic acid, carboxyethyl (meth)acrylate, carboxypentyl (meth)acrylate, itaconic acid, maleic acid, fumaric acid, and crotonic acid. Among them, acrylic acid is preferred from the viewpoint of copolymerizability, price, and improving the pressure-sensitive adhesive property of the pressure-sensitive adhesive layer.

The hydroxyl group-containing monomer is a compound containing a hydroxyl group in its structure and having a polymerizable unsaturated double bond such as a (meth)acryloyl group or a vinyl group. Examples of the hydroxyl group-containing monomer include: hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydoxyoctyl (meth)acrylate, 10-hydroxydecyl (meth)acrylate, and 12-hydroxylauryl (meth)acrylate; and (4-hydroxymethylcyclohexyl)-methylacrylate. Among them, 2-hydroxyethyl (meth)acrylate and 4-hydroxybutyl (meth)acrylate are preferred, and 4-hydroxybutyl (meth)acrylate is more preferred from the viewpoint of improving the durability of the pressure-sensitive adhesive layer.

When the pressure-sensitive adhesive composition contains a crosslinking agent that will be described later, the above-described copolymerizable monomer functions as a site of reaction with the crosslinking agent. The carboxyl group-containing monomer and the hydroxyl group-containing monomer are highly reactive with an intermolecular crosslinking agent, and are therefore preferably used to improve the cohesiveness and heat resistance of a resulting pressure-sensitive adhesive layer. Further, the carboxyl group-containing monomer is preferred from the viewpoint of achieving both durability and reworkability, and the hydroxyl group-containing monomer is preferred from the viewpoint of improving reworkability.

In the present invention, the amount of the alkyl (meth)acrylate is preferably 50 wt % or more with respect to the total amount of monomer components forming the (meth)acrylic polymer (A) from the viewpoint of improving the adhesiveness of the pressure-sensitive adhesive layer. The amount of the alkyl (meth)acrylate can freely be set as the balance of monomers other than the alkyl (meth)acrylate.

When the aromatic ring-containing (meth)acrylate is used as the monomer component, the amount of the aromatic ring-containing (meth)acrylate is preferably 3 to 25 wt % with respect to the total amount of the monomer components forming the (meth)acrylic polymer (A) from the viewpoint of improving the durability of the pressure-sensitive adhesive layer. The upper limit of the amount of the aromatic ring-containing (meth)acrylate to be copolymerized is more preferably 22 wt % or less, even more preferably 20 wt % or less. The lower limit of the amount of the aromatic ring-containing (meth)acrylate to be copolymerized is more preferably 8 wt % or more, even more preferably 12 wt % or more. If the amount of the aromatic ring-containing (meth)acrylate to be copolymerized is too large, light leakage tends to become worse due to the shrinkage of an optical film and reworkability tends to deteriorate. If the amount of the aromatic ring-containing (meth)acrylate to be copolymerized is too small, light leakage tends to become worse.

When the hydroxyl group-containing monomer is used as the monomer component, the amount of the hydroxyl group-containing monomer is preferably 0.01 to 10 wt % with respect to the total amount of the monomer components forming the (meth)acrylic polymer (A) from the viewpoint of improving the pressure-sensitive adhesive property and durability of the pressure-sensitive adhesive layer. The upper limit of the amount of the hydroxyl group-containing monomer to be copolymerized is more preferably 5 wt % or less, even more preferably 2 wt % or less, particularly preferably 1 wt % or less. The lower limit of the amount of the hydroxyl group-containing monomer to be copolymerized is more preferably 0.03 wt % or more, even more preferably 0.05 wt % or more. If the amount of the hydroxyl group-containing monomer to be copolymerized is too large, durability tends to reduce due to the hardening of the pressure-sensitive adhesive. If the amount of the hydroxyl group-containing monomer to be copolymerized is too small, durability tends to reduce due to poor crosslinking of the pressure-sensitive adhesive.

In the present invention, as the monomer component, another copolymerizable monomer having a polymerizable functional group having an unsaturated double bond, such as a (meth)acryloyl group or a vinyl group, can be used in addition to the above-described alkyl (meth)acrylate and the above-described copolymerizable monomer for the purpose of improving the adhesiveness and heat resistance of the pressure-sensitive adhesive layer. The other copolymerizable monomers may be used singly or in combination of two or more of them.

Examples of the another copolymerizable monomer include: acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; phosphoric acid group-containing monomers such as 2-hydroxyethylacryloyl phosphate; alkylaminoalkyl (meth)acrylates such as aminoethyl (meth)acrylate, N,N-dimethylaminoethyl (meth)acrylate, and t-butylaminoethyl (meth)acrylate; alkoxyalkyl (meth)acrylates such as methoxyethyl (meth)acrylate and ethoxyethyl (meth)acrylate; succinimide-based monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide-based monomers such as N-cyclohexylmaleimide, N-isopropylmaleimide, N-laurylmaleimide, and N-phenylmaleimide; itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide; vinyl-based monomers such as vinyl acetate and vinyl propionate; cyanoacrylate-based monomers such as acrylonitrile and methacrylonitrile; epoxy group-containing (meth)acrylates such as glycidyl (meth)acrylate; glycol-based (meth)acrylates such as polyethylene glycol (meth)acrylate, polypropylene glycol (meth)acrylate, methoxyethylene glycol (meth)acrylate, and methoxypolypropylene glycol (meth)acrylate; (meth)acrylate monomers such as tetrahydrofurfuryl (meth)acrylate, fluoro(meth)acrylate, silicone (meth)acrylate, and 2-methoxyethyl acrylate; and silicon atom-containing silane-based monomers such as 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltriethoxysilane, 10-methacryloyloxydecyltriethoxysilane, and 10-acryloyloxydecyltriethoxysilane.

Other examples of the another copolymerizable monomer include polyfunctional monomers having two or more unsaturated double bonds, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate.

When the another copolymerizable monomer is used as the monomer component, the amount of the another copolymerizable monomer is preferably 10 wt % or less, more preferably 7 wt % or less, even more preferably 5 wt % or less with respect to the total amount of the monomer components forming the (meth)acrylic polymer (A).

<Method for Producing (meth)acrylic Polymer (A)>

The (meth)acrylic polymer (A) can be produced by a known production method appropriately selected from various radical polymerization methods such as solution polymerization, radiation polymerization such as electron beam polymerization or UV polymerization, bulk polymerization, and emulsion polymerization. The resulting (meth)acrylic polymer (A) may be, for example, any one of a random copolymer, a block copolymer, and a graft copolymer.

It is to be noted that in the solution polymerization, for example, ethyl acetate or toluene is used as a polymerization solvent. In a specific example of the solution polymerization, the reaction is usually performed in a stream of an inert gas such as nitrogen at about 50 to 70° C. for about 5 to 30 hours in the presence of a polymerization initiator.

A polymerization initiator, a chain transfer agent, an emulsifier, and the like used in the radical polymerization are not particularly limited and can be appropriately selected. It is to be noted that the weight-average molecular weight of the (meth)acrylic polymer (A) can be controlled by the amount of the polymerization initiator or the chain transfer agent to be used or reaction conditions. The amount of the polymerization initiator or the chain transfer agent to be used is appropriately adjusted depending on the type thereof.

Examples of the polymerization initiator include, but are not limited to; azo-based initiators such as 2,2′-azobisisobutyronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (manufactured by Wako Pure Chemical Industries, Ltd., VA-057); persulfates such as potassium persulfate and ammonium persulfate; peroxide-based initiators such as di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; and redox-based initiators using a peroxide and a reducing agent in combination, such as a combination of a persulfate and sodium hydrogen sulfite and a combination of a peroxide and sodium ascorbate.

These polymerization initiators may be used singly or in combination of two or more of them. However, the total amount of the polymerization initiators to be used is preferably about 0.005 to 1 part by weight, more preferably about 0.01 to 0.5 parts by weight per 100 parts by weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. These chain transfer agents may be used singly or in combination of two or more of them. However, the total amount of the chain transfer agents to be used is about 0.1 parts by weight or less per 100 parts by weight of the monomer component.

Examples of the emulsifier used for emulsion polymerization include: anionic emulsifiers such as sodium lauryl sulfate, ammonium lauryl sulfate, sodium dodecylbenzene sulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymer. These emulsifiers may be used singly or in combination of two or more of them.

Specific examples of the emulsifier having a radical polymerizable functional group, such as a propenyl group or an allyl ether group, introduced thereinto, that is, a reactive emulsifier include Aqualon HS-10, HS-20, KH-10, BC-05, BC-10, and BC-20 (all manufactured by DKS Co., Ltd.) and ADEKA REASOAP SE10N (manufactured by ADEKA Corporation). The reactive emulsifier is taken into a polymer chain after polymerization, and is therefore preferred from the viewpoint of improving water resistance. The amount of the emulsifier to be used is preferably 0.3 to 5 parts by weight per 100 parts by weight of the total amount of the monomer components. From the viewpoint of polymerization stability and mechanical stability, the amount of the emulsifier to be used is more preferably 0.5 to 1 part by weight per 100 parts by weight of the total amount of the monomer components.

When the (meth)acrylic polymer (A) is produced by radiation polymerization, the monomer component is polymerized by exposure to radiation such as electron beams or UV rays. When the radiation polymerization is performed using electron beams, it is not particularly necessary to add a photopolymerization initiator to the monomer component. However, when the radiation polymerization is performed by UV polymerization, a photopolymerization initiator may be added to the monomer component because there is an advantage that polymerization time can particularly be reduced. The photopolymerization initiators may be used singly or in combination of two or more of them.

The photopolymerization initiator is not particularly limited as long as photopolymerization can be initiated, and may be one usually used. Examples of such a photopolymerization initiator include benzoin ether-based, acetophenone-based, α-ketol-based, photoactive oxime-based, benzoin-based, benzyl-based, benzophenone-based, ketal-based, and thioxanthone-based photopolymerization initiators. The amount of the photopolymerization initiator to be used is 0.05 to 1.5 parts by weight, preferably 0.1 to 1 part by weight per 100 parts by weight of the monomer component. These photopolymerization initiators may be used singly or in combination of two or more of them.

The (meth)acrylic polymer (A) usually used has a weight-average molecular weight of 1,000,000 to 2,500,000. In consideration of durability, especially heat resistance, the weight-average molecular weight is preferably 1,200,000 to 2,000,000. A weight-average molecular weight of less than 1,000,000 is not preferred in terms of heat resistance. If the weight-average molecular weight exceeds 2,500,000, the pressure-sensitive adhesive tends to become hard so that peeling is likely to occur. The molecular weight distribution of the (meth)acrylic polymer (A) represented as weight-average molecular weight (Mw)/number-average molecular weight (Mn) is preferably 1.8 to 10, more preferably 1.8 to 7, even more preferably 1.8 to 5. A molecular weight distribution (Mw/Mn) of more than 10 is not preferred in terms of durability. It is to be noted that the weight-average molecular weight and the molecular weight distribution (Mw/Mn) are determined from values measured by gel permeation chromatography (GPC) and calculated against polystyrene standards.

### <Silicon Compound (B)>

The silicon compound (B) used in the present invention is at least one silicon compound selected from the group consisting of an alkoxysilane compound and an organopolysiloxane compound, which have an acidic group or an acid anhydride group derived from an acidic group but have no polyether group in a molecule, and/or a hydrolytic condensate thereof. The acidic group or the acid anhydride group derived from an acidic group in a molecule is preferably a carboxyl group or a carboxylic anhydride group. Examples of the acid anhydride group include a succinic anhydride group, a phthalic anhydride group, and a maleic anhydride group. The acid anhydride group is preferably a succinic anhydride group, more preferably an acid anhydride group having an organic group represented by the following general formula (3) from the viewpoint that it is estimated to easily coordinate with a transition metal atom, such as a tin atom, present in a transparent conductive layer such as an ITO layer. The silicon compounds (B) may be used singly or in combination of two or more of them.

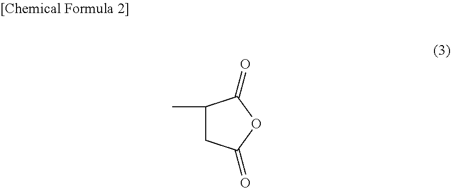

The alkoxysilane compound that has an acidic group or an acid anhydride group derived from an acidic group but has no polyether group in a molecule is not limited as long as it is a silane coupling agent that has an acidic group or an acid anhydride group derived from an acidic group but has no polyether group in a molecule, and examples such a silane coupling agent include, but are not limited to, compounds represented by a general formula (4): R¹R²ₐSi(OR³)₃₋ₐ. In the general formula (4), R¹ is a linear, branched, or cyclic organic group having 1 to 20 carbon atoms and an acid anhydride group, R² is independently a hydrogen atom or a monovalent hydrocarbon group that has 1 to 20 carbon atoms and may be substituted with a halogen atom, R³s are each independently an alkyl group having 1 to 10 carbon atoms, and a is an integer of 0 or 1.

In the general formula (4), R¹ is preferably an organic group represented by the following general formula (5) from the viewpoint of ease of availability:

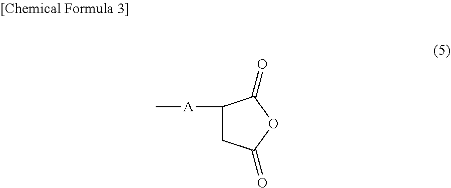

wherein A is a linear or branched alkylene or alkenylene group having 2 to 10 carbon atoms, preferably a linear or branched alkylene group having 2 to 6 carbon atoms).

Examples of the alkoxysilane compound that has an acidic group or an acid anhydride group derived from an acidic group but has no polyether group in a molecule include 2-trimethoxysilylethyl succinic anhydride (manufactured by Shin-Etsu Chemical Co., Ltd. under the trade name of “X-12-967C”), 3-trimethoxysilylpropyl succinic anhydride, 3-triethoxysilylpropyl succinic anhydride, 3-methyldiethoxysilylpropyl succinic anhydride, and 1-carboxy-3-triethoxysilylpropyl succinic anhydride.

Examples of the organopolysiloxane compound that has an acidic group or an acid anhydride group derived from an acidic group but has no polyether group in a molecule include, but are not limited to, organopolysiloxane compounds (b1) which have an alkoxy group and an acid anhydride group in a molecule and in which at least one kind of siloxane unit is introduced by forming a siloxane bond between an O atom and an Si atom in at least one O—Si bond present in the molecule of an alkoxysilane represented by a general formula (6): R¹ₙSi(OR²)₄₋ₙ (wherein R¹ is independently a hydrogen atom or a C1 to C20 monovalent hydrocarbon group that may be substituted with a halogen atom, R²s are each independently an alkyl group having 1 to 10 carbon atoms, and n is an integer of 0 or 1) or a partial hydrolytic condensate thereof, wherein the siloxane unit to be introduced contains 1 to 100 siloxane units represented by a formula A of the following general formula (7) and 0 to 100 siloxane units represented by a formula B of the following general formula (7) and introduced if necessary:

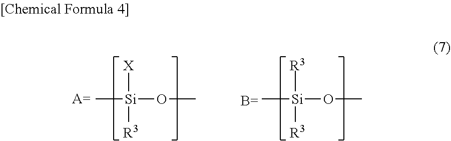

(wherein X is a monovalent hydrocarbon group having an acid anhydride group, preferably a monovalent hydrocarbon group containing an organic group represented by the above general formula (5), R³s are each independently a hydrogen atom or a C1 to C20 monovalent hydrocarbon group that may be substituted with a halogen atom).

Examples of the alkoxysilane represented by the above general formula (6) or the partial hydrolytic condensate thereof include tetramethoxysilane, methyltrimethoxysilane, tetraethoxysilane, methyltriethoxysilane, and partial hydrolytic condensate of each of these silanes or a combination of two or more of these silanes.

The number of the siloxane units represented by the formula A of the general formula (7) is preferably 1 to 100, more preferably 1 to 50, even more preferably 1 to 20. Further, the number of the siloxane units represented by the formula B of the general formula (7) and introduced if necessary is preferably 0 to 100, more preferably 0 to 50, even more preferably 0 to 20. When the siloxane unit represented by the formula B is contained, the number of the siloxane units represented by the formula B is preferably 1 or more. It is to be noted that the above different siloxane units may be introduced into the same O—Si bond or may separately be introduced into different O—Si bonds.

A method for producing the organopolysiloxane compound (b1) is not limited. For example, the organopolysiloxane compound (b1) can be obtained by a known production method disclosed in JP-A-2013-129809 or JP-A-2013-129691.

From the viewpoint of improving the reworkability and corrosion resistance of the pressure-sensitive adhesive layer, the silicon compound (B) is preferably the above-described organopolysiloxane compound that has an acidic group or an acid anhydride group derived from an acidic group but has no polyether group in a molecule.

From the viewpoint of improving the high durability, reworkability, and corrosion resistance of the pressure-sensitive adhesive layer, the amount of the silicon compound (B) is preferably 0.05 to 10 parts by weight per 100 parts by weight of the (meth)acrylic polymer (A). The upper limit of the amount of the silicon compound (B) to be added is more preferably 3 parts by weight or less, even more preferably 2 parts by weight or less, particularly preferably 1 part by weight or less, most preferably 0.6 parts by weight or less. The lower limit of the amount of the silicon compound (B) to be added is more preferably 0.1 parts by weight or more, even more preferably 0.2 parts by weight or more, particularly preferably 0.4 parts by weight or more. If the amount of the silicon compound (B) to be added is too large, corrosion resistance and durability tend to reduce. If the amount of the silicon compound (B) to be added is too small, reworkability, corrosion resistance, and durability tend to reduce.

### <Phosphonic Acid-Based Compound or Phosphoric Acid-Based Compound or Salt Thereof>

The phosphonic acid-based compound used in the present invention is represented by the following general formula (8):

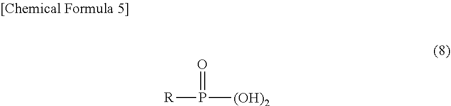

In the general formula (8), R is a hydrogen atom or a C1 to C18 hydrocarbon group that may contain an oxygen atom. Examples of the C1 to C18 hydrocarbon group that may contain an oxygen atom include C1 to C18 alkyl groups, C1 to C18 alkenyl groups, and C6 to C18 aryl groups. The alkyl groups and the alkenyl groups may be either linear or branched.

In the present invention, the phosphonic acid-based compound may be phosphonic acid represented by the general formula (8) wherein R is a hydrogen atom (HP(═O)(OH)₂). A salt (e.g., a metallic salt such as a sodium salt, a potassium salt, or a magnesium salt or an ammonium salt) of the phosphonic acid may also be suitably used.

Specific examples of the phosphonic acid-based compound represented by the general formula (8) include phosphonic acid, methylphosphonic acid, ethylphosphonic acid, n-propylphosphonic acid, isopropylphosphonic acid, n-butylphosphonic acid, tert-butylphosphonic acid, sec-butylphosphonic acid, isobutylphosphonic acid, n-pentylphosphonic acid, n-hexylphosphonic acid, isohexylphosphonic acid, n-heptylphosphonic acid, n-octylphosphonic acid, isooctylphosphonic acid, tert-octylphosphonic acid, n-nonylphosphonic acid, n-decylphosphonic acid, isodecylphosphonic acid, n-dodecylphosphonic acid, isododecylphosphonic acid, n-tetradecylphosphonic acid, n-hexadecylphosphonic acid, n-octadecylphosphonic acid, n-eicosylphosphonic acid, cyclobutylphosphonic acid, cyclopentylphosphonic acid, cyclohexylphosphonic acid, norbornylphosphonic acid, phenylphosphonic acid, naphthylphosphonic acid, biphenylphosphonic acid, methoxyphenylphosphonic acid, ethoxyphenylphosphonic acid, and salts thereof. In the present invention, these phosphonic acid-based compounds may be used singly or in combination of two or more of them.

A dimer, trimer, or the like of the phosphonic acid-based compound represented by the general formula (8) may also be suitably used.

### <Reactive Functional Group-Containing Silane Coupling Agent>

The pressure-sensitive adhesive composition used in the present invention may contain a reactive functional group-containing silane coupling agent. The reactive functional group-containing silane coupling agent contains, as the reactive functional group, a functional group other than an acid anhydride group. The functional group other than an acid anhydride group is preferably at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group. The reactive functional group-containing silane coupling agents may be used singly or in combination of two or more of them.

Examples of the reactive functional group-containing silane coupling agent include: epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; mercapto group-containing silane coupling agents such as 3-mercaptopropylmethyldimethoxysilane and 3-mercaptopropyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; isocyanate group-containing silane coupling agents such as 3-isocyanatopropyltriethoxysilane; vinyl group-containing silane coupling agents such as vinyltrimethoxysilane and vinyltriethoxysilane; styryl group-containing silane coupling agents such as p-styryltrimethoxysilane; and (meth)acrylic group-containing silane coupling agents such as 3-acryloxypropyltrimethoxysilane and 3-methacryloxypropyltriethoxysilane. Among them, epoxy group-containing silane coupling agents and mercapto group-containing silane coupling agents are preferred.

As the reactive functional group-containing silane coupling agent, one having two or more alkoxysilyl groups in its molecule (oligomer-type silane coupling agent) may also be used. Specific examples thereof include: epoxy group-containing oligomer-type silane coupling agents manufactured by Shin-Etsu Chemical Co., Ltd. under the trade names of “X-41-1053”, “X-41-1059A”, “X-41-1056”, and “X-40-2651”; and mercapto group-containing oligomer-type silane coupling agents manufactured by Shin-Etsu Chemical Co., Ltd. under the trade names of “X-41-1818”, “X-41-1810”, and “X-41-1805”. The oligomer-type silane coupling agent is preferred because it is less likely to evaporate, and has two or more alkoxysilyl groups and is therefore effective at improving durability.

When the reactive functional group-containing silane coupling agent is added to the pressure-sensitive adhesive composition, the amount of the reactive functional group-containing silane coupling agent is preferably 0.001 to 5 parts by weight per 100 parts by weight of the (meth)acrylic polymer (A). The upper limit of the amount of the reactive functional group-containing silane coupling agent to be added is more preferably 1 part by weight or less, even more preferably 0.6 parts by weight or less. The lower limit of the amount of the reactive functional group-containing silane coupling agent to be added is more preferably 0.01 parts by weight or more, even more preferably 0.05 parts by weight or more, particularly preferably 0.1 parts by weight or more. If the amount of the reactive functional group-containing silane coupling agent added is too large, durability tends to reduce, and if the amount of the reactive functional group-containing silane coupling agent to be added is too small, its effect on improving durability tends to be poor.

Further, when the reactive functional group-containing silane coupling agent is added to the pressure-sensitive adhesive composition, the weight ratio between the silicon compound (B) and the reactive functional group-containing silane coupling agent (silicon compound (B)/reactive functional group-containing silane agent) is preferably 0.1 or more, more preferably 0.5 or more, even more preferably 1 or more and is preferably 50 or less, more preferably 15 or less, even more preferably 5 or less from the viewpoint of improving the durability of the pressure-sensitive adhesive layer.

### <Crosslinking Agent>

The pressure-sensitive adhesive composition used in the present invention may contain a crosslinking agent. The crosslinking agent to be used may be an organic crosslinking agent, a polyfunctional metallic chelate, or the like. Examples of the organic crosslinking agent include an isocyanate-based crosslinking agent, a peroxide-based crosslinking agent, an epoxy-based cross-linking agent, and an imine-based crosslinking agent. The polyfunctional metallic chelate contains a polyvalent metal and an organic compound which are covalently or coordinately bonded to each other. Examples of the polyvalent metallic atom include Al, Cr, Zr, Co, Cu, Fe, Ni, V, Zn, In, Ca, Mg, Mn, Y, Ce, Sr, Ba, Mo, La, Sn, and Ti. The organic compound contains an oxygen atom or the like as an atom that forms a covalent or coordinate bond. Examples of the organic compound include alkyl esters, alcohol compounds, carboxylic compounds, ether compounds, and ketone compounds. The crosslinking agents may be used singly or in combination of two or more of them.

The crosslinking agent is preferably an isocyanate-based crosslinking agent and/or a peroxide-based crosslinking agent, more preferably a combination of an isocyanate-based crosslinking agent and a peroxide-based crosslinking agent.

The isocyanate-based crosslinking agent to be used may be a compound having at least two isocyanate groups (including functional groups obtained by temporarily protecting isocyanate groups with a blocking agent or by oligomerization so as to convertible to isocyanate groups). Examples of such a compound include known aliphatic polyisocyanate, alicyclic polyisocyanate, and aromatic polyisocyanate that are generally used for urethanization reaction.

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Other examples of the isocyanate-based crosslinking agent include multimers (e.g., dimers, trimers, pentamers), urethane-modified products obtained by reaction with a polyhydric alcohol such as trimethylolpropane, urea-modified products, biuret-modified products, allophanate-modified products, isocyanurate-modified products, and carbodiimide-modified products of the above-mentioned diisocyanates.

Examples of a commercially-available product of the isocyanate-based crosslinking agent include products manufactured by Tosoh Corporation under the trade names of “Millionate MT” “Millionate MTL”, “Millionate MR-200”, “Millionate MR-400”, “Coronate L”, “Coronate HL”, and “Coronate HX” and products manufactured by Mitsui Chemicals Inc. under the trade names of “TAKENATE D-110N”, “TAKENATE D-120N” “TAKENATE D-140N” “TAKENATE D-160N” “TAKENATE D-165N”, “TAKENATE D-170HN”, “TAKENATE D-178N”, “TAKENATE 500”, and “TAKENATE 600”.

The isocyanate-based crosslinking agent is preferably an aromatic polyisocyanate, an aromatic polyisocyanate-based compound that is a modified product of the aromatic polyisocyanate, an aliphatic polyisocyanate, or an aliphatic polyisocyanate-based compound that is a modified product of the aliphatic polyisocyanate. The aromatic polyisocyanate-based compound is suitably used for its excellent balance between crosslinking speed and pot life. Particularly preferred examples of the aromatic polyisocyanate-based compound include tolylenediisocyanate and modified products thereof.

The peroxide can appropriately be used as long as it generates a radical active species by heating or light irradiation to promote the crosslinking of the base polymer ((meth)acrylic polymer (A)) of the pressure-sensitive adhesive composition. In consideration of workability and stability, a peroxide whose one-minute half-life temperature is 80° C. to 160° C. is preferably used, and a peroxide whose one-minute half-life temperature is 90° C. to 140° C. is more preferably used.

Examples of the peroxide include di(2-ethylhexyl)peroxydicarbonate (one-minute half-life temperature: 90.6° C.), di(4-t-butylcyclohexyl)peroxydicarbonate (one-minute half-life temperature: 92.1° C.), di-sec-butylperoxydicarbonate (one-minute half-life temperature: 92.4° C.), t-butylperoxyneodecanoate (one-minute half-life temperature: 103.5° C.), t-hexylperoxypivalate (one-minute half-life temperature: 109.1° C.), t-butylperoxypivalate (one-minute half-life temperature: 110.3° C.), dilauroylperoxide (one-minute half-life temperature: 116.4° C.), di-n-octanoylperoxide (one-minute half-life temperature: 117.4° C.), 1,1,3,3-tetramethylbutylperoxy-2-ethylhexanoate (one-minute half-life temperature: 124.3° C.), di(4-methylbenzoyl)peroxide (one-minute half-life temperature: 128.2° C.), dibenzoylperoxide (one-minute half-life temperature: 130.0° C.), t-butylperoxyisobutyrate (one-minute half-life temperature: 136.1° C.), and 1,1-di(t-hexylperoxy)cyclohexane (one-minute half-life temperature: 149.2° C.). Among them, di(4-t-butylcyclohexyl)peroxydicarbonate (one-minute half-life temperature: 92.1° C.), dilauroyl peroxide (one-minute half-life temperature: 116.4° C.), and dibenzoylperoxide (one-minute half-life temperature: 130.0° C.) are particularly excellent in crosslinking reaction efficiency.

It is to be noted that the half-life of a peroxide is an indicator of the decomposition speed of the peroxide, and refers to the time it takes to reduce the amount of the peroxide to half its initial amount. The decomposition temperatures at which specific half-life times of peroxides are obtained and the half-life times of peroxides at specific temperatures are shown in manufacturer's catalogs such as “ORGANIC PEROXIDES 9th EDITION (May, 2003)” of NOF Corporation.

When the crosslinking agent is added to the pressure-sensitive adhesive composition, the amount of the crosslinking agent is preferably 0.01 to 3 parts by weight, more preferably 0.02 to 2 parts by weight, even more preferably 0.03 to 1 part by weight per 100 parts by weight of the (meth)acrylic polymer (A). It is to be noted that if the amount of the crosslinking agent is less than 0.01 parts by weight, there is a fear that the pressure-sensitive adhesive layer cannot have satisfactory durability and pressure-sensitive adhesive property due to poor crosslinking. On the other hand, if the amount of the crosslinking agent exceeds 3 parts by weight, the pressure-sensitive adhesive layer tends to be excessively hard and therefore have low durability.

When the isocyanate-based crosslinking agent is added to the pressure-sensitive adhesive composition, the amount of the isocyanate-base crosslinking agent is preferably 0.01 to 2 parts by weight, more preferably 0.02 to 2 parts by weight, even more preferably 0.05 to 1.5 parts by weight per 100 parts by weight of the (meth)acrylic polymer (A). From the viewpoint of cohesive force and preventing peeling in an endurance test, the amount of the isocyanate-based crosslinking agent is appropriately selected from the above range.

When the peroxide is added to the pressure-sensitive adhesive composition, the amount of the peroxide is preferably 0.01 to 2 parts by weight, more preferably 0.04 to 1.5 parts by weight, even more preferably 0.05 to 1 part by weight per 100 parts by weight of the (meth)acrylic polymer. In order to adjust processability and crosslinking stability, the amount of the peroxide is appropriately selected from the above range.

### <Other Components>

The pressure-sensitive adhesive composition used in the present invention may contain an ionic compound. The ionic compound is not particularly limited, and an ionic compound used in this field may suitably be used. Examples of such an ionic compound include those disclosed in JP 2015-4861 A. Among them, (perfluoroalkylsulfonyl)imide lithium salts are preferred, and lithium bis(trifluoromethanesulfonylimide) is more preferred. The ratio of the ionic compound is not particularly limited as long as the effects of the present invention are not impaired. For example, the ratio of the ionic compound is preferably 10 parts by weight or less, more preferably 5 parts by weight or less, even more preferably 3 parts by weight or less, particularly preferably 1 part by weight or less per 100 parts by weight of the (meth)acrylic polymer (A).

The pressure-sensitive adhesive composition used in the present invention may contain other known dopants. For example, the following dopants may appropriately be added depending on the intended use: powders of colorants or pigments, dyes, surfactants, plasticizers, tackifiers, surface lubricants, leveling agents, softeners, antioxidants, anti-aging agents, light stabilizers, UV absorbers, polymerization inhibitors, inorganic or organic fillers, metallic powders, and granular or foil-shaped materials. A redox system may be used by adding a reducing agent within a controllable range. The amount of these dopants to be used is preferably 5 parts by weight or less, more preferably 3 parts by weight or less, even more preferably 1 part by weight or less per 100 parts by weight of the (meth)acrylic polymer (A).

### <Pressure-Sensitive Adhesive Layer>

The pressure-sensitive adhesive layer is formed using the pressure-sensitive adhesive composition. When the pressure-sensitive adhesive layer is formed, it is preferred that the total amount of the crosslinking agents to be added is adjusted and the effects of the temperature and time of crosslinking treatment are sufficiently taken into consideration.

The temperature and time of crosslinking treatment can be adjusted depending on the type of crosslinking agent used. The temperature of crosslinking treatment is preferably 170° C. or less. The crosslinking treatment may be performed at the same temperature as in the step of drying the pressure-sensitive adhesive layer, or may be performed in a crosslinking treatment step separately provided after the drying step. The time of crosslinking treatment can be set in consideration of productivity and workability, but is usually about 0.2 to 20 minutes, preferably about 0.5 to 10 minutes.

A method for forming the pressure-sensitive adhesive layer is not particularly limited, and may be a method in which the pressure-sensitive adhesive composition is applied onto any substrate, dried with a drier such as a heating oven to evaporate a solvent or the like, and if necessary, subjected to the above-described crosslinking treatment to form a pressure sensitive adhesive layer, and the pressure-sensitive adhesive layer is transferred onto an optical film or a transparent conductive substrate that will be described later. Alternatively, the pressure-sensitive adhesive layer may be formed by directly applying the pressure-sensitive adhesive composition onto the optical film or the transparent conductive substrate. In the present invention, a method is preferred in which an optical film having a pressure-sensitive adhesive layer is previously formed by forming a pressure-sensitive adhesive layer on an optical film, and then the optical film having a pressure-sensitive adhesive layer is attached to a liquid crystal cell.

The substrate is not particularly limited, and examples thereof include various substrates such as a release film, a transparent resin film substrate, and a polarizing film that will be described later.

Various methods may be used to apply the pressure-sensitive adhesive composition onto the substrate or the optical film. Specific examples thereof include methods such as fountain coater, roll coating, kiss-roll coating, gravure coating, reverse coating, roll brushing, spray coating, dip roll coating, bar coating, knife coating, air knife coating, curtain coating, lip coating, and extrusion coating suing a die coater.

Conditions (temperature, time) for the drying are not particularly limited, and may be appropriately set depending on, for example, the composition and concentration of the pressure-sensitive adhesive composition. The temperature is, for example, about 80 to 170° C., preferably 90 to 200° C., and the time is, for example, 1 to 60 minutes, preferably 2 to 30 minutes. If necessary, crosslinking treatment may be performed after drying, and conditions therefor are as described above.

The thickness of the pressure-sensitive adhesive layer (after drying) is, for example, preferably 5 to 100 μm, more preferably 7 to 70 μm, even more preferably 10 to 50 μm. If the thickness of the pressure-sensitive adhesive layer is less than 5 μm, the pressure-sensitive adhesive layer is poor in adhesiveness to an adherend, and therefore its durability tends to be poor under humidified conditions. On the other hand, if the thickness of the pressure-sensitive adhesive layer exceeds 100 μm, the pressure-sensitive adhesive composition is not sufficiently dried when applied and dried to form the pressure-sensitive adhesive layer so that foam remains and the pressure-sensitive adhesive layer has surface irregularities causing thickness variations, and therefore a problem in external appearance is likely to become apparent.

Examples of a material constituting the release film include appropriate thin sheet-shaped materials such as resin films such as polyethylene, polypropylene, polyethylene terephthalate, and polyester films, porous materials such as paper, fabric, and nonwoven fabric, nets, foamed sheets, metallic foils, and laminates of two or more of them. From the viewpoint of excellent surface smoothness, resin films are suitably used. Examples of the resin films include polyethylene films, polypropylene films, polybutene films, polybutadiene films, polymethylpentene films, polyvinyl chloride films, vinyl chloride copolymer films, polyethylene terephthalate film, polybutylene terephthalate films, polyurethane films, and ethylene-vinyl acetate copolymer films.

The thickness of the release film is usually about 5 to 200 μm, preferably about 5 to 100 μm. If necessary, the release film may be subjected to release and antifouling treatment using a silicone-, fluorine-, long chain alkyl- or fatty acid amide-based releasing agent or a silica powder or antistatic treatment by coating, kneading, or vapor deposition. Particularly, releasability from the pressure-sensitive adhesive layer can further be improved by appropriately subjecting the surface of the release film to release treatment, such as silicone treatment, long-chain alkyl treatment, or fluorine treatment.

The transparent resin film substrate is not particularly limited, and various resin films having transparency are used. The resin film is formed from a single-layer film. Examples of a material thereof include polyester-based resins such as polyethylene terephthalate and polyethylene naphthalate, acetate-based resins, polyethersulfone-based resins, polycarbonate-based resins, polyamide-based resins, polyimide-based resins, polyolefin-based resins, (meth)acrylic resins, polyvinyl chloride-based resins, polyvinylidene chloride-based resins, polystyrene-based resins, polyvinyl alcohol-based resins, polyarylate-based resins, and polyphenylenesulfide-based resins. Among them, polyester-based resins, polyimide-based resins, and polyethersulfone-based resins are particularly preferred. The film substrate preferably has a thickness of 15 to 200 μm.

### <Optical Film Having Pressure-Sensitive Adhesive Layer>

An optical film having a pressure-sensitive adhesive layer according to the present invention includes the above-described pressure-sensitive adhesive layer provided on at least one of surfaces of an optical film. It is to be noted that a method for forming the pressure-sensitive adhesive layer is as described above.

As the optical film, one for use in producing an image display device such as a liquid crystal display is used, and the type of the optical film is not particularly limited. An example of the optical film is a polarizing film. As the polarizing film, one having a polarizer and a transparent protective film provided on one or both of the surfaces of the polarizer is generally used. Other examples of the optical film include optical layers for use in producing a liquid crystal display, such as a reflector, a transreflector, a retardation film (including a half wavelength plate or a quarter wavelength plate), a viewing angle compensation film, and a brightness enhancement film. These optical films may be used singly, or one or two or more of these optical films may be laminated on the polarizing film when practically used.

The polarizer is not particularly limited, and various polarizers may be used. Examples of the polarizer include a product obtained by uniaxially stretching a hydrophilic polymer film, such as a polyvinyl alcohol-based film, a partially-formalized polyvinyl alcohol-based film, or partially-saponified ethylene-vinyl acetate copolymer-based film, to which a dichroic material such as iodine or a dichroic dye has been adsorbed, or a polyene-based oriented film such as a dehydration product of polyvinyl alcohol or a dehydrochlorination product of vinyl chloride. Among them, a polarizer including a polyvinyl alcohol-based film and a dichroic material such as iodine is preferred, and an iodine-based polarizer containing iodine and/or an iodine ion is more preferred. The thicknesses of these polarizers are not particularly limited, but are generally about 5 to 80 μm.

The polarizer constituted from a uniaxially-stretched polyvinyl alcohol-based film dyed with iodine can be produced by immersing polyvinyl alcohol in an aqueous iodine solution to dye the polyvinyl alcohol and stretching the polyvinyl alcohol 3 to 7 times its original length. If necessary, the polyvinyl alcohol may be immersed in an aqueous solution of potassium iodide or the like that may contain boric acid, zinc sulfate, zinc chloride, or the like. Further, if necessary, the polyvinyl alcohol-based film may be immersed in water for washing before dyeing. By washing the polyvinyl alcohol-based film with water, soil or a blocking agent on the surface of the polyvinyl alcohol-based film can be washed away, and the polyvinyl alcohol-based film can be swelled, which is effective at preventing uneven dyeing. The stretching may be performed either before or after dyeing with iodine, or may be performed while dyeing is performed. The polyvinyl alcohol-based film may be stretched in an aqueous solution of boric acid or potassium iodide or a water bath.

In the present invention, a thin polarizer having a thickness of 10 μm or less may also be used. From the viewpoint of thickness reduction, the thickness is preferably 1 to 7 μm. Such a thin polarizer is preferred because it has a small thickness variation, excellent visibility, and excellent durability due to a small dimensional change, and the thickness of the polarizing film can be reduced.

Typical examples of the thin polarizer include thin polarizing films disclosed in JP 51-069644 A, JP 2000-338329 A, WO 2010/100917, WO 2010/100917, Japanese Patent No. 4751481, and JP 2012-073563 A. These thin polarizing films can be obtained by a method including the step of stretching a laminate of a polyvinyl alcohol-based resin (hereinafter, also referred to as PVA-based resin) layer and a resin substrate for stretching and the step of dyeing. This production method makes it possible to perform stretching without a problem such as fracture caused by stretching even when the PVA-based resin layer is thin because the PVA-based resin layer is supported by the resin substrate for stretching.

Among the thin polarizing films obtained by such a production method including the step of stretching a laminate and the step of dyeing, from the viewpoint that high ratio stretching can be performed to improve polarization performance, those disclosed in WO 2010/100917, WO 2010/100917, Japanese Patent No. 4751481, and JP 2012-073563 A are preferred which are obtained by production methods including the step of performing stretching in an aqueous boric acid solution, and those disclosed in Japanese Patent No. 4751481 and JP 2012-073563 A are particularly preferred, which are obtained by production methods including the step of performing auxiliary in-air stretching before stretching in an aqueous boric acid solution.

As a material for forming the transparent protective film provided on one or both of the surfaces of the polarizer, for example, a thermoplastic resin is used which is excellent in transparency, mechanical strength, thermal stability, moisture barrier properties, and isotropy. Specific examples of such a thermoplastic resin include cellulose resins such as triacetyl cellulose, polyester resins, polyethersulfone resins, polysulfone resins, polycarbonate resins, polyamide resins, polyimide resins, polyolefin resins, (meth)acrylic resins, cyclic polyolefin resins (norbornene-based resins), polyarylate resins polystyrene resins, polyvinyl alcohol resins, and mixtures of two or more of them. It is to be noted that the transparent protective film is adhered to one of the surfaces of the polarizer with an adhesive layer, but on the other surface of the polarizer, a (meth)acrylic, urethane-based, acrylic urethane-based, epoxy-based, or silicone-based thermosetting or UV-curable resin may be used as a transparent protective film. The transparent protective film may contain any one or more appropriate dopants. Examples of the dopants include a UV absorber, an antioxidant, a lubricant, a plasticizer, a releasing agent, an anti-coloring agent, a flame retardant, a nucleating agent, an antistatic agent, a pigment, and a coloring agent. The amount of the thermoplastic resin contained in the transparent protective film is preferably 50 to 100 wt %, more preferably 50 to 99 wt %, even more preferably 60 to 98 wt %, particularly preferably 70 to 97 wt %. If the amount of the thermoplastic resin contained in the transparent protective film is 50 wt % or less, there is a fear that high transparency that the thermoplastic resin originally has cannot sufficiently be developed.

The thickness of the protective film can appropriately be set, but is usually about 10 to 200 μm from the viewpoint of strength, workability such as handleability, and thinness.

The polarizer and the protective film are usually closely adhered to each other via a water-based adhesive or the like. Examples of the water-based adhesive include isocyanate-based adhesives, polyvinyl alcohol-based adhesives, gelatin-based adhesives, vinyl-based latex-based, water-based polyurethanes, and water-based polyesters. Other than the above, a UV-curable adhesive or an electron beam-curable adhesive may be used as an adhesive for adhering the polarizer and the transparent protective film to each other. The electron beam-curable adhesive for polarizing film has appropriate adhesiveness to the above-mentioned various transparent protective films. The adhesive may contain a metallic compound filler.

In the present invention, a retardation film or the like may be formed on the polarizer instead of the transparent protective film of the polarizing film. Further, another transparent protective film or a retardation film may further be provided on the transparent protective film.

The surface of the transparent protective film to which the polarizer is not adhered may have a hard coat layer formed thereon, or may be subjected to anti-reflection treatment, treatment for preventing sticking, or treatment for the purpose of diffusion or anti-glare.

Further, an anchor layer may be provided between the polarizing film and the pressure-sensitive adhesive layer. A material for forming the anchor layer is not particularly limited, and examples thereof include various polymers, sols of metallic oxides, and silica sol. Among them, polymers are particularly preferably used. The polymers to be used may be of any of a solvent-soluble type, a water-dispersible type, and a water-soluble type.

Examples of the polymers include polyurethane-based resins, polyester-based resins, acrylic resins, polyether-based resins, cellulose-based resins, polyvinyl alcohol-based resins, polyvinyl pyrrolidone, and polystyrene-based resins.

When the pressure-sensitive adhesive layer of the optical film having a pressure-sensitive adhesive layer is exposed, the pressure-sensitive adhesive layer may be protected with a release film (separator) until the optical film having a pressure-sensitive adhesive layer is practically used. Examples of the release film include those mentioned above. When a release film is used as a substrate for forming the pressure-sensitive adhesive layer, and the pressure-sensitive adhesive layer on the release film and an optical film are adhered to each other, the release film can be used as a release film for the pressure-sensitive adhesive layer of the resulting optical film having a pressure-sensitive adhesive layer, which makes it possible to simplify the production process.

### <Transparent Conductive Substrate>

The optical film having a pressure-sensitive adhesive layer according to the present invention may be adhered to a transparent conductive layer of a transparent conductive substrate in which the transparent conductive layer is provided on a transparent substrate, and the resultant may be used as an optical laminate.

A material for forming the transparent conductive layer of the transparent conductive substrate is not particularly limited. For example, an oxide of at least one metal selected from the group consisting of indium, tin, zinc, gallium, antimony, titanium, silicon, zirconium, magnesium, aluminum, gold, silver, copper, palladium, and tungsten is used. If necessary, the metallic oxide may further contain a metallic atom shown in the above group. For example, an indium-tin composite oxide (indium oxide containing tin oxide, ITO), tin oxide containing antimony, or the like is preferably used, and ITO is particularly preferably used. The ITO preferably contains 80 to 99 wt % of indium oxide and 1 to 20 wt % of tin oxide.

Examples of the ITO include crystalline ITO and amorphous ITO, and either of them can suitably be used.

The thickness of the transparent conductive layer is not particularly limited, and is preferably 10 nm or more, more preferably 15 to 40 nm, even more preferably 20 to 30 nm.

A method for forming the transparent conductive layer is not particularly limited, and a conventionally-known method may be used. Specific examples of the method include vacuum deposition, sputtering, and ion plating. Depending on a desired film thickness, an appropriate method may be used.

A material of the transparent substrate is not particularly limited as long as a transparent substrate can be obtained, and examples thereof include glass and a transparent resin film substrate. Examples of the transparent resin film substrate include those mentioned above.

If necessary, an undercoat layer, an oligomer blocking layer, or the like may be provided between the transparent conductive layer and the transparent substrate.

### <Image Display Device>

An image display device according to the present invention includes a liquid crystal cell or an organic EL cell having the above-described optical laminate, wherein the pressure-sensitive adhesive layer of the above0described optical film having a pressure-sensitive adhesive layer is adhered to at least one surface of the liquid crystal cell or the organic EL cell.

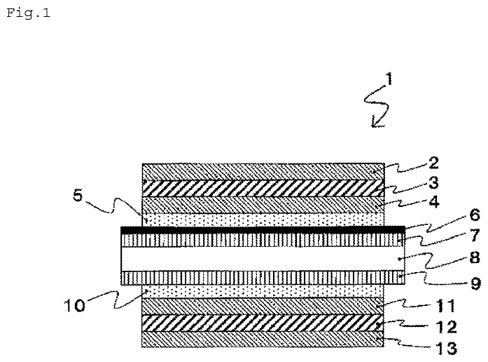

The liquid crystal cell used in the image display device according to the present invention includes a transparent conductive substrate in which a transparent conductive layer is provided on a transparent substrate. The transparent conductive substrate is usually provided on the viewing side of the liquid crystal cell. A liquid crystal cell-containing liquid crystal panel usable in the present invention will be described with reference to FIG. 1. However, the present invention is not limited to what is shown in FIG. 1.

An example of a liquid crystal panel 1 that may be included in the image display device according to the present invention has a structure in which, from the viewing side, a viewing-side transparent protective film 2. a polarizer 3, a liquid crystal cell-side transparent protective film 4, a pressure-sensitive adhesive layer 5, a transparent conductive layer 6, a transparent substrate 7, a liquid crystal layer 8, a transparent substrate 9/a pressure-sensitive adhesive layer 10, a liquid crystal cell-side transparent protective film 11, a polarizer 12, and a light source-side transparent protective film 13 are provided. In FIG. 1, a polarizing film having a pressure-sensitive adhesive layer used as the optical film having a pressure-sensitive adhesive layer according to the present invention corresponds to a structure having the viewing side-transparent protective film 2, the polarizer 3, the liquid crystal cell-side transparent protective film 4, and the pressure-sensitive adhesive layer 5. Further, in FIG. 1, a transparent conductive substrate used in the present invention corresponds to a structure having the transparent conductive layer 6 and the transparent substrate 7. Further, in FIG. 1, a liquid crystal cell having the transparent conductive substrate used in the present invention corresponds to a structure having the transparent conductive layer 6, the transparent substrate 7, the liquid crystal layer 8, and the transparent substrate 9.

In addition to the above constituents, the liquid crystal panel 1 may appropriately include optical films such as a retardation film, a viewing angle compensation film, and a brightness enhancement film.

The liquid crystal layer 8 is not particularly limited, and may be of any type such as a TN type, an STN type, a n type, a VA type, or an IPS type. A material of the transparent substrate 9 (light source side) is not particularly limited as long as a transparent substrate can be obtained. Examples of such a material include glass and a transparent resin film substrate. Examples of the transparent resin film substrate include those mentioned above.

As the light source-side pressure-sensitive adhesive layer 10, the liquid crystal cell-side transparent protective film 11, the polarizer 12, and the light source-side transparent protective film 13, those conventionally used in this field may be used or those mentioned in this description may also be suitably used.

Examples of an image display device to which the liquid crystal panel can be applied include a liquid crystal display device, an electroluminescence (EL) display, a plasma display (PD), and a field emission display (FED). The image display device can be used in home appliances, cars, public information displays (PIDs), and the like, and are particularly preferably used in cars and PIDs because the pressure-sensitive adhesive layer according to the present invention has reworkability, corrosion resistance, and high durability against a transparent conductive layer.

### EXAMPLES

Hereinbelow, the present invention will specifically be described with reference to examples, but is not limited to these examples. It is to be noted that part(s) and % in each of the examples are all by weight. In the following description, conditions for allowing any material to stand at room temperature are 23° C. and 65% RH unless otherwise specified.

<Measurement of Weight-Average Molecular Weight of (meth)acrylic Polymer (A)>

The weight-average molecular weight (Mw) of a (meth)acrylic polymer (A) was measured by GPC (gel permeation chromatography). The Mw/Mn was also measured in the same manner.
Analyzer: HLC-8120GPC manufactured by Tosoh Corporation
Column: G7000H_{XL}+GMH_{XL}+GMH_{XL} manufactured by Tosoh Corporation
Column size: 7.8 mmφ×30 cm (each column), total: 90 cm
Column temperature: 40° C.
Flow rate: 0.8 mL/min
Injected amount: 100 μL
Eluent: Tetrahydrofuran
Detector: Differential refractometer (RI)
Standard sample: polystyrene

### Synthetic Examples 1 and 2

<Synthesis of Organopolysiloxane Compounds Having Acidic Group or Acid Anhydride Group Derived from Acidic Group but No Polyether Group in Molecule>

According to Example 1 in JP 2013-129809 A, organopolysiloxane compounds (B1) and (B2) having an acidic group or an acid anhydride group derived from an acidic group but no polyether group in a molecule were each obtained by synthesis so as to have a composition shown in Table 1.

TABLE 1

| | | | Ratio of | Ratio of |
|---|---|---|---|---|
| | | Ratio of | silicon | silicon |
| Silicon | Kind of | silicon | having acid | having |
| compound | alkoxy | having alkoxy | anhydride | polyether |
| (B) | group | group (mol %) | group (mol %) | group (mol %) |
| (B1) | Methoxy | 73 | 27 | — |
| (B2) | Ethoxy | 70 | 30 | — |

### <Analysis of Composition of Organopolysiloxane Compound>

The composition of each of the organopolysiloxane compounds was determined by ¹H-NMR measurement performed under the following conditions.
Analyzer: AVANCEIII 600 with Cryo Probe manufactured by Bruker Biospin
Observing frequency: 600 MHz (1H)
Measurement solvent: CDCl₃
Measurement temperature: 300 K
Chemical shift reference: measurement solvent [1H: 7.25 ppm]

### Comparative Synthetic Example 1

<Synthesis of Organopolysiloxane Compound Having Acidic Group or Acid Anhydride Group Derived from Acidic Group and Polyether Group in Molecule>

According to Example 2 described in JP 2013-129809 A, an organopolysiloxane compound (B3) having an acidic group or an acid anhydride group derived from an acidic group and a polyether group in a molecule was obtained by synthesis so as to have a composition shown in Table 2.

TABLE 2

| | | | Ratio of | Ratio of |
|---|---|---|---|---|
| | | Ratio of | silicon | silicon |
| Silicon | Kind of | silicon | having acid | having |
| compound | alkoxy | having alkoxy | anhydride | polyether |
| (B) | group | group (mol %) | group (mol %) | group (mol %) |
| (B3) | Methoxy | 63 | 24 | 13 |

### <Preparation of Polarizing Film>

A polyvinyl alcohol film having a thickness of 80 μm was stretched to 3 times between rolls different in velocity ratio while dyed in a 0.3% iodine solution at 30° C. for 1 minute. Then, the film was stretched to a total stretch ratio of 6 times while immersed in an aqueous solution containing 4% of boric acid and 10% of potassium iodide at 60° C. for 0.5 minutes. Then, the film was washed by immersion in an aqueous solution containing 1.5% of potassium iodide at 30° C. for 10 seconds, and was then dried at 50° C. for 4 minutes to obtain a polarizer having a thickness of 30 μm. A saponified triacetyl cellulose film having a thickness of 80 μm was adhered to both surfaces of the polarizer with a polyvinyl alcohol-based adhesive to prepare a polarizing film.

### Example 1

### <Preparation of Acrylic Polymer (A1)>

In a four-necked flask equipped with a stirring blade, a thermometer, a nitrogen gas inlet tube, and a cooler, a monomer mixture containing 76.9 parts of butyl acrylate, 18 parts of benzyl acrylate, 5 parts of acrylic acid, and 0.1 parts of 4-hydroxybutyl acrylate was placed. Further, 0.1 parts of 2,2′-azobisisobutyronitrile was placed as a polymerization initiator together with 100 parts of ethyl acetate per 100 parts of the monomer mixture (solid matter). Nitrogen gas was introduced into the flask for nitrogen purging while the mixture in the flask was gently stirred. Then, a polymerization reaction was performed for 8 hours while the temperature of the liquid in the flask was kept at about 55° C. to prepare a solution of an acrylic polymer (A1) having a weight-average molecular weight (Mw) of 1,950,000 and a Mw/Mn ratio of 3.9.

### <Preparation of Pressure-Sensitive Adhesive Composition>

To 100 parts of the solid matter of the solution of the acrylic polymer (A1) obtained above, 0.4 parts of an isocyanate crosslinking agent (trimethylol propane/tolylene diisocyanate adduct manufactured by Tosoh Corporation under the trade name of “Coronate L”), 0.1 parts of a peroxide crosslinking agent (manufactured by NOF CORPORATION under the trade name of “NYPER BMT”), and 0.05 parts of the organopolysiloxane compound (B1) synthesized in Synthetic Example 1 were added to prepare a solution of an acrylic pressure-sensitive adhesive composition.

### <Production of Polarizing Film Having Pressure-Sensitive Adhesive Layer>

Then, the solution of the acrylic pressure-sensitive adhesive composition obtained above was applied onto one surface of a polyethylene terephthalate film treated with a silicone-based releasing agent (separator film manufactured by Mitsubishi Polyester Film Corporation under the trade name of “MRF38”) so that a pressure-sensitive adhesive layer had a thickness of 20 μm after drying, and was then dried at 155° C. for 1 minute to form a pressure-sensitive adhesive layer on the surface of the separator film. Then, the pressure-sensitive adhesive layer formed on the separator film was transferred onto the polarizing film prepared above to produce a polarizing film having a pressure-sensitive adhesive layer.

### Examples 2 to 15, Comparative Examples 1 to 5

The kinds of monomers used to prepare an acrylic polymer and the ratio among the monomers used in Example 1 were changed as shown in Table 3 and production conditions were controlled to prepare solutions of acrylic polymers having polymer properties (weight-average molecular weight, Mw/Mn) shown in Table 3.

Solutions of acrylic pressure-sensitive adhesive compositions were prepared using the obtained solutions of the acrylic polymers in the same manner as in Example 1 except that the kind or amount of the silicon compound (B) used, the kind or amount of a reactive functional group-containing silane coupling agent used (or a reactive functional group-containing silane coupling agent was not used), the kind or amount of a phosphonic acid-based compound or a phosphoric acid-based compound or a salt thereof used (or a phosphonic acid-based compound or a phosphoric acid-based compound or a salt thereof was not used), and/or the amounts of the crosslinking agents used were changed as shown in Table 3. Further, polarizing films having a pressure-sensitive adhesive layer were produced using the solutions of the acrylic pressure-sensitive adhesive compositions in the same manner as in Example 1.

The polarizing films having a pressure-sensitive adhesive layer obtained above in Examples and Comparative Examples were evaluated in the following manner. The evaluation results are shown in Table 3.

### <Measurement of Adhesive Force>

The polarizing film having a pressure-sensitive adhesive layer was cut to have a size of 150×25 mm wide, adhered to an adherend with a laminator, and subjected to autoclave treatment at 50° C. and 5 atm for 15 minutes for complete adhesion. Then, the adhesive force of the sample was measured. The adhesive force was determined by measuring a force (N/25 mm, 80 m long in measurement) required to peel the sample using a tensile tester (Autograph SHIMADZU AG-1 10 KN) at a peel angle of 90° and a peel rate of 300 mm/min. In the measurement, sampling was performed once per 0.5 s, and an average of measured values was used as a measured value.

As the adherends, a 0.7 mm-thick alkali-free glass plate (manufactured by Corning under the trade name of “EG-XG”) and an ITO-coated glass plate obtained by forming an ITO film on the alkali-free glass plate by sputtering were used to measure the adhesive force against each of the alkali-free glass plate and the ITO. The ITO used had an Sn content of 3 wt %. The Sn content of the ITO was calculated by the formula: weight of Sn atoms/(weight of Sn atoms+weight of In atoms).

From the viewpoint of reworkability, the adhesive force of the pressure-sensitive adhesive layer according to the present invention is preferably 15 N/25 mm or less, more preferably 10 N/25 mm or less, even more preferably 8 N/25 mm or less.

### <Corrosivity Against ITO>

An ITO-coated glass plate that was the same as that used for measuring adhesive force was cut to have a size of 25 mm×25 mm to prepare an adherend. The polarizing plate having a pressure-sensitive adhesive layer was cut to have a size of 15 mm×15 mm, and was adhered to the central portion of the adherend, and was then subjected to autoclave treatment at 50° C. and 5 atm for 15 minutes to prepare a sample for evaluating corrosivity against ITO. The surface resistance value (Ω/□) of ITO of the obtained evaluation sample was measured and defined as Rᵢ.

Then, the sample for measurement was placed in an environment of 65° C. and 95% RH for 250 hours, and then the surface resistance value (Ω/□) was measured and defined as R₂₅₀. Similarly, the sample for measurement was placed in an environment of 65° C. and 95% RH for 500 hours, and then the surface resistance value (Ω/□) was measured and defined as R₅₀₀. The resistance values were measured using HL5500PC manufactured by Accent Optical Technologies. The Rᵢ, R₂₅₀, and R₅₀₀ measured in such a manner as descried above were used to calculate a resistance value change ratio between R₂₅₀ and Rᵢ(R₂₅₀/Rᵢ) and a resistance value change ratio between R₅₀₀ and R₂₅₀ (R₅₀₀/R₂₅₀).

### <Endurance Test>

An ITO-coated glass plate that was the same as that used for measuring adhesive force was used as an adherend. The polarizing film having a pressure-sensitive adhesive layer cut to have a size of 300×220 mm was adhered to the ITO-coated glass plate with a laminator. Then, the sample was subjected to autoclave treatment at 50° C. and 0.5 MPa for 15 minutes to be completely adhered to the ITO-coated glass plate. The sample subjected to such treatment was treated in an atmosphere of 95° C. or 105° C. for 500 hours (heating test) or treated in an atmosphere of 65° C./95% RH for 500 hours (humidification test), and then the appearance of the interface between the polarizing film and the glass plate was visually observed and evaluated according to the following criteria.

(Evaluation Criteria)

⊙: No change in appearance such as foaming or peeling was observed.

◯: Peeling at edges or foaming was slightly observed, which however did not cause any problem in practical use.

Δ: Peeling at edges or foaming was observed, which however did not practically cause any problem in applications other than special applications.

x: Significant peeling was observed ad edges, which caused a problem in practical use.

### <Reworkability Test>

An ITO-coated glass plate that was the same as that used for measuring adhesive force was used as an adherend. The polarizing film having a pressure-sensitive adhesive layer was cut to have a size of 420 mm long×320 mm wide, adhered to the ITO-coated glass plate with a laminator, subjected to autoclave treatment at 50° C. and 5 atm for 15 minutes for complete adhesion, and then manually peeled off from the ITO-coated glass plate. The test was repeated three times in the above manner to evaluate the reworkability according to the following criteria.

⊙: All the three films could successfully be peeled off without adhesive residue and breakage.

◯: One or two of the three films were broken but could be peeled off by re-peeling.

Δ: All the three films were broken but could be peeled off by re-peeling.

x: None of the three films could be peeled off without adhesive residue or could be peeled off even by repeated peeling due to breakage.

TABLE 3

| | | | | | | | | | | | | | Phosphonic | |
|---|---|---|---|---|---|---|---|---|---|---|---|---|---|---|
| | | | | | | | | | | | | | acid-based | |
| | | | | | | | | | | | Reactive | | compound or | |
| | | | | | | | | | | | functional | | phosphoric | |
| | (Meth)acrylic polymer (A) | | | | | | | | | | group-containing | | acid-based | |
| | | | | | | | Molecular | | Silicon | | silicon | | compound or | |
| | | Composition | | | | | weight | | compound (a) | | coupling agent | | salt thereof | |
| | No. | BA | BxA | NVP | AA | HBA | Mw | Mw/Mn | Kind | parts | Kind | parts | Kind | parts |
| Example 1 | (A1) | 76.9 | 18 | | 5 | 0.1 | 1,950,000 | 3.9 | (B1) | 0.05 | — | — | | |
| Example 2 | (A1) | 76.9 | 18 | | 5 | 0.1 | 1,950,000 | 3.9 | (B1) | 0.1 | — | — | | |
| Example 3 | (A1) | 76.9 | 18 | | 5 | 0.1 | 1,950,000 | 3.9 | (B1) | 0.3 | — | — | | |
| Example 4 | (A1) | 76.9 | 18 | | 5 | 0.1 | 1,950,000 | 3.9 | (B1) | 6.4 | — | — | | |
| Example 5 | (A1) | 76.9 | 18 | | 5 | 0.1 | 1,950,000 | 3.9 | (B1) | 0.6 | — | — | | |
| Example 6 | (A1) | 76.9 | 18 | | 5 | 0.1 | 1,950,000 | 3.9 | (B1) | 1 | — | — | | |
| Example 7 | (A1) | 76.9 | 18 | | 5 | 0.1 | 1,950,000 | 3.9 | (B1) | 2 | — | — | | |
| Example 8 | (A1) | 76.9 | 18 | | 5 | 0.1 | 1,950,000 | 3.9 | (B1) | 3 | — | — | | |
| Example 9 | (A1) | 76.9 | 18 | | 5 | 0.1 | 1,950,000 | 3.9 | (B2) | 1 | — | — | | |
| Example 10 | (A2) | 76.9 | 18 | 2 | 3 | 0.1 | 1,800,000 | 3.5 | (B1) | 0.4 | — | — | | |
| Example 11 | (A3) | 77.5 | 18 | 4.4 | | 0.1 | 1,680,000 | 3.8 | (B1) | 0.2 | — | — | | |
| Example 12 | (A1) | 76.9 | 18 | | 5 | 0.1 | 1,950,000 | 3.9 | (B1) | 0.6 | X-41- | 0.2 | | |
| | | | | | | | | | | | 1056 | | | |
| Example 13 | (A1) | 76.9 | 18 | | 5 | 0.1 | 1,950,000 | 3.9 | (B1) | 0.4 | X-41- | 0.2 | | |
| | | | | | | | | | | | 1810 | | | |
| Example 14 | (A1) | 76.9 | 18 | | 5 | 0.1 | 1,950,000 | 3.9 | X-12- | 0.2 | — | — | | |
| | | | | | | | | | 967C | | | | | |
| Example 15 | (A1) | 76.9 | 18 | | 5 | 0.1 | 1,950,000 | 3.9 | (B1) | 0.4 | — | — | MP-4 | 0.05 |
| Comparative | (A1) | 76.9 | 18 | | 5 | 0.1 | 1,950,000 | 3.9 | — | — | — | — | | |
| Example 1 | | | | | | | | | | | | | | |
| Comparative | (A1) | 76.9 | 18 | | 5 | 0.1 | 1,950,000 | 3.9 | X-41- | 0.2 | — | — | | |
| Example 2 | | | | | | | | | 1056 | | | | | |
| Comparative | (A1) | 76.9 | 18 | | 5 | 0.1 | 1,950,000 | 3.9 | (B3) | 0.4 | — | — | | |
| Example 3 | | | | | | | | | | | | | | |
| Comparative | (A1) | 76.9 | 18 | | 5 | 0.1 | 1,950,000 | 3.9 | [symbol] | 0.4 | — | — | | |
| Example 4 | | | | | | | | | | | | | | |
| Comparative | (A4) | 99 | | | 1 | | 1,800,000 | 4.1 | — | — | — | — | | |
| Example 5 | | | | | | | | | | | | | | |

| | | | | | Resistance | | | | | |
|---|---|---|---|---|---|---|---|---|---|---|
| | | | Adhesive | | value change | | | | | |
| | Crosslinking | | force | | ratio | | Durability | | | |
| | agent | | (N/25 mm) | | R [symbol] / | R [symbol] / | | | 65° C. | Reworkability |
| | Isocyanate | Peroxide | ITO | Class | R [symbol] | R [symbol] | 95° C. | 105° C. | 95% RH | test |
| Example 1 | 0.4 | 0.1 | 14.8 | 10.9 | 2.75 | 1.73 | ◯ | Δ | ◯ | Δ |
| Example 2 | 0.4 | 0.1 | 11.2 | 10.4 | 1.43 | 1.57 | ◯ | ◯ | ◯ | Δ |
| Example 3 | 0.4 | 0.1 | 8.3 | 8.0 | 1.20 | 1.04 | ◯ | ◯ | ◯ | ◯ |
| Example 4 | 0.4 | 0.1 | 6.6 | 5.0 | 1.19 | 1.12 | ⊙ | ⊙ | ◯ | ⊙ |
| Example 5 | 0.4 | 0.1 | 6.3 | 5.7 | 1.26 | 1.17 | ⊙ | ⊙ | ◯ | ⊙ |
| Example 6 | 0.4 | 0.1 | 5.6 | 4.9 | 1.39 | 1.29 | ⊙ | ⊙ | ◯ | ⊙ |
| Example 7 | 0.4 | 0.1 | 5.2 | 4.7 | 1.86 | 1.38 | ◯ | ◯ | ◯ | ⊙ |
| Example 8 | 0.4 | 0.1 | 4.8 | 4.8 | 2.89 | 1.39 | ◯ | ◯ | Δ | ⊙ |
| Example 9 | 0.4 | 0.1 | 8.8 | 7.5 | 1.48 | 1.76 | ◯ | ◯ | ◯ | ◯ |
| Example 10 | 0.6 | 0.2 | 6.0 | 6.0 | 1.10 | 1.09 | ⊙ | ⊙ | ◯ | ⊙ |
| Example 11 | 0.3 | 0.3 | 5.9 | 7.0 | 1.05 | 1.10 | ◯ | Δ | ◯ | ⊙ |
| Example 12 | 0.4 | 0.1 | 6.0 | 5.0 | 1.18 | 1.12 | ⊙ | ⊙ | ⊙ | ⊙ |
| Example 13 | 0.4 | 0.1 | 6.3 | 6.0 | 1.15 | 1.15 | ⊙ | ⊙ | ⊙ | ⊙ |
| Example 14 | 0.4 | 0.1 | 15.9 | 12.1 | 1.98 | 2.01 | ◯ | ◯ | ◯ | Δ |
| Example 15 | 0.4 | 0.1 | 7.0 | 7.0 | 1.07 | 1.06 | ⊙ | ⊙ | ◯ | ⊙ |
| Comparative | 0.4 | 0.1 | 16.1 | 11.9 | 4.89 | 1.01 | ◯ | X | X | X |
| Example 1 | | | | | | | | | | |
| Comparative | 0.4 | 0.1 | 15.6 | 6.0 | 4.66 | 1.05 | ◯ | X | ◯ | Δ |
| Example 2 | | | | | | | | | | |
| Comparative | 0.4 | 0.1 | 6.0 | 5.5 | 4.78 | 1.05 | Δ | X | ◯ | ⊙ |
| Example 3 | | | | | | | | | | |
| Comparative | 0.4 | 0.1 | 16.0 | 11.9 | 4.45 | 1.10 | X | X | Δ | X |
| Example 4 | | | | | | | | | | |
| Comparative | 0.1 | 0.3 | 4.5 | 5 | 1.10 | 1.09 | X | X | X | ⊙ |
| Example 5 | | | | | | | | | | |

[symbol]

indicates data missing or illegible when filed

In Table 3, the monomers used to prepare the (meth)acrylic polymers (A) are represented by the following abbreviations:

BA: butyl acrylate;

BzA: benzyl acrylate;

NVP: N-vinyl-pyrrolidone;

AA: acrylic acid; and

HBA: 4-hydroxybutyl acrylate.

In Table 3, X-12-967C represents 2-trimethoxysilylethylsuccinic anhydride (manufactured by Shin-Etsu Chemical Co., Ltd.);

X-41-1056 represents an epoxy group-containing oligomer-type silane coupling agent (manufactured by Shin-Etsu Chemical Co., Ltd.);

X-41-1810 represents a mercapto group-containing oligomer-type silane coupling agent (manufactured by Shin-Etsu Chemical Co., Ltd.);

PDMS represents polydimethylsiloxane (manufactured by Shin-Etsu Chemical Co., Ltd. under the trade name of “KF-96-20CS”);

MP-4 represents monobutyl phosphate (n-butyl phosphate) (manufactured by DAIHACHI CHEMICAL INDUSTRY CO., LTD.);

Isocyanate represents an isocyanate crosslinking agent (manufactured by Tosoh Corporation under the trade name of “Coronate L”, trimethylolpropane/tolylenediisocyanate adduct); and

Peroxide represents a peroxide crosslinking agent (manufactured by NOF Corporation under the trade name of “NYPER BMT”).

### DESCRIPTION OF REFERENCE SIGNS

1 Liquid crystal panel
2 Viewing-side transparent protective film
3 Polarizer
4 Liquid crystal cell-side transparent protective film
5 Pressure-sensitive adhesive layer
6 Transparent conductive layer
7 Transparent substrate
8 Liquid crystal layer
9 Transparent substrate
10 Pressure-sensitive adhesive layer
11 Liquid crystal cell-side transparent protective film
12 Polarizer
13 Light source-side transparent protective film

1. A pressure-sensitive adhesive layer comprising a pressure-sensitive adhesive composition containing a (meth)acrylic polymer (A) containing at least an alkyl (meth)acrylate as a monomer unit and a silicon compound (B), wherein
the silicon compound (B) is at least one silicon compound selected from the group consisting of an alkoxysilane compound and an organopolysiloxane compound which have an acidic group or an acid anhydride group derived from an acidic group but have no polyether group in a molecule, and/or a hydrolytic condensate thereof, and
the pressure-sensitive adhesive layer satisfies a condition of a resistance value change ratio represented by the following general formula (1): R₂₅₀/Rᵢ≤3.0 (1)
(wherein the Rᵢ represents a surface resistance value (Ω/□) of an indium-tin composite oxide layer at a time when a laminate, which is obtained by adhering the pressure-sensitive adhesive layer of a polarizing film having a pressure-sensitive adhesive layer which has a polarizing film and the pressure-sensitive adhesive layer to the indium-tin composite oxide layer of a transparent conductive substrate having a transparent substrate and the indium-tin composite oxide layer, is subjected to autoclave treatment under conditions of 50° C. and 5 atmospheres for 15 minutes, and the R₂₅₀ represents a surface resistance value (Ω/□) of the indium-tin composite oxide layer at a time when the laminate that has been subjected to autoclave treatment is subjected to high-temperature and high-humidity treatment under conditions of 65° C. and 95% RH for 250 hours).

2. The pressure-sensitive adhesive layer according to claim 1, which satisfies a condition of a resistance value change ratio represented by the following general formula (2):
R₅₀₀/R₂₅₀≤1.8 (2)
(wherein the R₅₀₀ represents a surface resistance value (Ω/□) of the indium-tin composite oxide layer at a time when the laminate that has been subjected to autoclave treatment is subjected to high-temperature and high-humidity treatment under conditions of 65° C. and 95% RH for 500 hours).

3. The pressure-sensitive adhesive layer according to claim 1, wherein in the silicon compound (B), the acidic group or the acid anhydride group derived from an acidic group is a carboxyl group or a carboxylic acid anhydride group.

4. The pressure-sensitive adhesive layer according to claim 1, wherein an amount of the silicon compound (B) is 0.05 to 10 parts by weight per 100 parts by weight of the (meth)acrylic polymer (A).

5. The pressure-sensitive adhesive layer according to claim 1, wherein the pressure-sensitive adhesive composition contains a reactive functional group-containing silane coupling agent, and
the reactive functional group is a functional group other than an acid anhydride group.

6. The pressure-sensitive adhesive layer according to claim 5, wherein in the reactive functional group-containing silane coupling agent, the functional group other than an acid anhydride group is at least one of an epoxy group, a mercapto group, an amino group, an isocyanate group, an isocyanurate group, a vinyl group, a styryl group, an acetoacetyl group, a ureido group, a thiourea group, a (meth)acrylic group, and a heterocyclic group.

7. The pressure-sensitive adhesive layer according to claim 5, wherein an amount of the reactive functional group-containing silane coupling agent is 0.01 to 10 parts by weight per 100 parts by weight of the (meth)acrylic polymer (A).

8. The pressure-sensitive adhesive layer according to claim 1, wherein the pressure-sensitive adhesive composition further contains, as a monomer unit, at least one copolymerizable monomer selected from the group consisting of an aromatic-containing (meth)acrylate, an amide group-containing monomer, a carboxyl group-containing monomer, and a hydroxyl group-containing monomer.

9. The pressure-sensitive adhesive layer according to claim 8, wherein an amount of the carboxyl group-containing monomer is 0.1 to 15% by weight with respect to a total amount of monomer components forming the (meth)acrylic polymer (A).

10. The pressure-sensitive adhesive layer according to claim 1, wherein the pressure-sensitive adhesive composition contains a crosslinking agent.

11. The pressure-sensitive adhesive layer according to claim 1, whose adhesive force to an indium-tin composite oxide layer is 15 N/25 mm or less under conditions of a peel angle of 90° and a peel rate of 300 mm/min.

12. An optical film having a pressure-sensitive adhesive layer, comprising an optical film and the pressure-sensitive adhesive layer according to claim 1.

13. An optical laminate comprising a transparent conductive substrate having a transparent substrate and a transparent conductive layer and the optical film having a pressure-sensitive adhesive layer according to claim 12, wherein the pressure-sensitive adhesive layer of the optical film having a pressure-sensitive adhesive layer is adhered to the transparent conductive layer of the transparent conductive substrate.

14. An image display device using the optical film having a pressure-sensitive adhesive layer according to claim 12.

15. An image display device using the optical laminate according to claim 13.
